(19) United States
(12) Patent Application Publication
(10) Pub. No.: US 2016/0342665 A1
(43) Pub. Date: Nov. 24, 2016

(54) INTERACTIVE COMMAND LINE FOR CONTENT CREATION

(71) Applicant: Microsoft Technology Licensing, LLC, Redmond, WA (US)

(72) Inventors: Mira Lane, Bellevue, WA (US); Larry Waldman, Seattle, WA (US); Chad Voss, Seattle, WA (US); William J. Bliss, Los Angeles, CA (US); Luis Efrain Regalado de Loera, Redmond, WA (US)

(73) Assignee: Microsoft Technology Licensing, LLC, Redmond, WA (US)

(21) Appl. No.: 14/801,067

(22) Filed: Jul. 16, 2015

Related U.S. Application Data
(60) Provisional application No. 62/165,739, filed on May 22, 2015.
(60) Provisional application No. 62/165,856, filed on May 22, 2015.

(51) Int. Cl. G06F 17/30; H04L 12/58; G06F 3/0484

(52) U.S. Cl. CPC G06F 17/30557; G06F 3/0484; H04L 51/046

(57) ABSTRACT

Non-limiting examples of the present disclosure describe a collaborative communication system that may interface with one or more command resources. The collaborative communication system may comprise at least one memory and at least one processor operatively connected with the memory to execute operations. In response to command input being received during authoring in a user interface of the collaborative communication system, a query is processed and passed to a command resource. The query comprises parameters of the command input and a context associated with the authoring. A response is received from the command resource based on the parameters of the command input and the context. The response may comprise result data and parameters for interacting with the collaborative communication system. The result data is presented in the user interface of the collaborative communication system. Other examples are also described.

### CROSS-REFERENCE TO RELATED APPLICATIONS

This application claims priority to U.S. Provisional Application Ser. No. 62/165,739, entitled “INTERACTIVE COMMAND LINE FOR CONTENT CREATION,” filed on May 22, 2015, and U.S. Provisional Application Ser. No. 62/165,880, entitled “UNIFIED MESSAGING PLATFORM AND INTERFACE FOR PROVIDING RICH EMAIL MESSAGES,” filed on May 22, 2015, the entire disclosures of which are hereby incorporated herein by reference.

### BACKGROUND

Numerous and diverse communications platforms are currently available. Some communications platforms, e.g., messaging and/or email platforms, allow for a certain amount of interoperability. However, these platforms fail to adequately address the needs and requirements of contemporary team environments. Common communication services are fairly static and limited with respect to capabilities during authoring of a communication in a team environment. Further, third-party services typically register with a communication service but have limited interaction with the communication service thereafter. It is with respect to such general technical areas that the present application is directed.

### SUMMARY

Non-limiting examples of the present disclosure describe a collaborative communication system that may interface with one or more command resources. The collaborative communication system may comprise at least one memory and at least one processor operatively connected with the memory to execute operations. In response to command input being received during authoring in a user interface of the collaborative communication system, a query is processed and passed to a command resource. The query comprises parameters of the command input and a context associated with the authoring. A response is received from the command resource based on the parameters of the command input and the context. The response may comprise result data and parameters for interacting with the collaborative communication system. The result data is presented in the user interface of the collaborative communication system.

In additional non-limiting examples, the present disclosure describes a collaborative communication system that may interface with one or more external resources. In response to command input being received during authoring in a user interface of the collaborative communication system, a request is transmitted that comprises parameters of the command input and a context associated with the authoring. A response is received from an external resource based on the parameters of the command input and the context. The response may comprise result data and parameters for interacting with the collaborative communication system. The result data is presented in the user interface of the collaborative communication system.

In other non-limiting examples, registration data of a command handler is received from an external resource for a command that is executable in a collaborative communication service. The registration data comprises parameters defining a command associated with the command handler. The registration data is stored in a storage for the collaborative communication service. Upon receiving a declaration of input in the collaborative communication service, utilizing the parameters defining the command to determine whether the input triggers the command handler. Upon determining that the input triggers the command handler, presenting the stored command handler for display in a user interface of the collaborative communication service.

Other non-limiting examples of the present disclosure describe communication between a collaborative communication service and at least one external resource. Upon command input being received during authoring in a user interface of the collaborative communication service, a first query is transmitted to the external resource. The first query comprises parameters of the command input and a context associated with the authoring. A first response is received from the external resource based on the parameters of the command input and the context. The first response may comprise result data and parameters for interacting with the collaborative communication service. The result data is presented in the user interface. Upon update to the command input a second query is transmitted to the external resource. The second query comprises parameters of the updated command input. A second response is received from the external resource based on the parameters of the command input and the context provided by the first query. In examples, the second response received comprises updated result data. The updated result data is presented in the user interface.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an exemplary conceptual model for a unified communication platform, according to examples described herein.

FIG. 2A illustrates an exemplary interface for interacting with the unified communication platform, according to examples described herein.

FIG. 2B illustrates an exemplary interface for interacting with the unified communication platform, according to examples described herein.

FIG. 2C illustrates an exemplary interface for interacting with the unified communication platform, according to examples described herein.

FIG. 2D illustrates an exemplary interface for interacting with the unified communication platform, according to examples described herein.

FIG. 2E illustrates an exemplary interface for interacting with the unified communication platform, according to examples described herein.

FIG. 2F illustrates an exemplary mobile interface for interacting with the unified communication platform, according to examples described herein.

FIG. 2G illustrates an exemplary mobile interface for interacting with the unified communication platform, according to examples described herein.

FIG. 3 illustrates an exemplary system implemented on a computing device for command line interaction, according to examples described herein.

FIG. 4A illustrates an exemplary method for interaction between the unified communication platform and an external resource, according to examples described herein.

FIG. 4B illustrates an exemplary method executed by a third-party service, according to examples described herein.

FIG. 4C illustrates an exemplary method for processing performed by the unified communication platform, according to examples described herein.

FIG. 4D illustrates an exemplary method for evaluating communications between the unified communication platform and a command resource, according to examples described herein.

FIG. 5A illustrates an exemplary interface for interacting with the unified communication platform, according to examples described herein.

FIG. 5B illustrates an exemplary interface for interacting with the unified communication platform, according to examples described herein.

FIG. 5C illustrates an exemplary interface for interacting with the unified communication platform, according to examples described herein.

FIG. 5D illustrates an exemplary interface for interacting with the unified communication platform, according to examples described herein.

FIG. 6A illustrates an exemplary views for displaying content in the unified communication platform, according to examples described herein.

FIG. 6B illustrates an exemplary views for displaying content in the unified communication platform, according to examples described herein.

FIG. 6C illustrates an exemplary user interface component of the unified communication platform, according to examples described herein.

FIG. 7 is a block diagram illustrating example physical components of a computing device with which aspects of the disclosure may be practiced.

FIGS. 8A and 8B are simplified block diagrams of a mobile computing device with which aspects of the present disclosure may be practiced.

FIG. 9 is a simplified block diagram of a distributed computing system in which aspects of the present disclosure may be practiced.

FIG. 10 illustrates a tablet computing device for executing one or more aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems, computer-readable storage devices or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Communication services are becoming more advanced. However, communication services are fairly static with respect to capabilities during authoring of a communication. As an example, a user might be able to quickly say or enter input such as “service, please open my calendar.” However, previous communication systems/services are unable to interact with a user to process a command such as, “/meetingtime <Person 1, Person 2, Person 3>” and have an autocomplete entry show suggestions for when to suggest a meeting between the 3 specified persons. Accordingly, common communication services do not allow a user to deeply and efficiently interact with third-party services to craft a back-and-forth interaction between third-party services and the communication services.

Non-limiting examples of the present disclosure describe communication systems/services that afford for interaction with external services that is richer than mere register and forget interactions that currently exist between communication services and external services. Examples provided comprise systems and/or services that enable rich background communication with a plurality of external resources including third-party services to facilitate multi-step queries during authoring of content. In one example, a personal assistant service may register a set of handlers, that when triggered, may prompt for dynamic interactions during authoring of content such as a message/email. For instance, a user typing a new message could type “Hi John. I suggest we meet/mynextfreetimes.” Using examples described herein, a communication service may be able to interact with a third-party service for command processing to insert content that replaces the command “/mynextfreetimes” with the times that John is free. Exemplary communication systems/services described herein may foster further communication with external services to improve a user's experience with the exemplary communication system/services. Continuing the above example, a user may enter a command requesting additional available times to meet with John and the communication system/service may continue interaction with the external service to satisfy the request of the user. In another example, the user could enter an input of, “Sandy—I really like that /Assistant ‘What were docs from last meeting?’ Essentially, such an input may be asking a personal digital assistant service for a list of the documents presented in the last meeting. The personal assistant service may respond with a rich answer, perhaps in auto complete form, allowing the user to pick the documents they wanted to reference and then continue authoring a message. Accordingly, examples described herein enable for rich authoring integration.

A number of technical advantages are achieved based on the present disclosure including but not limited to: creation of a robust and scalable communication service, improved communication/interaction between an exemplary communication service and external services, processing efficiency with regard to input processing, improved user interaction between users and an exemplary communication service, improved efficiency and usability for UI control, reduction in error rate for input processing, and miniaturization or less space required for UI functionality, among other examples.

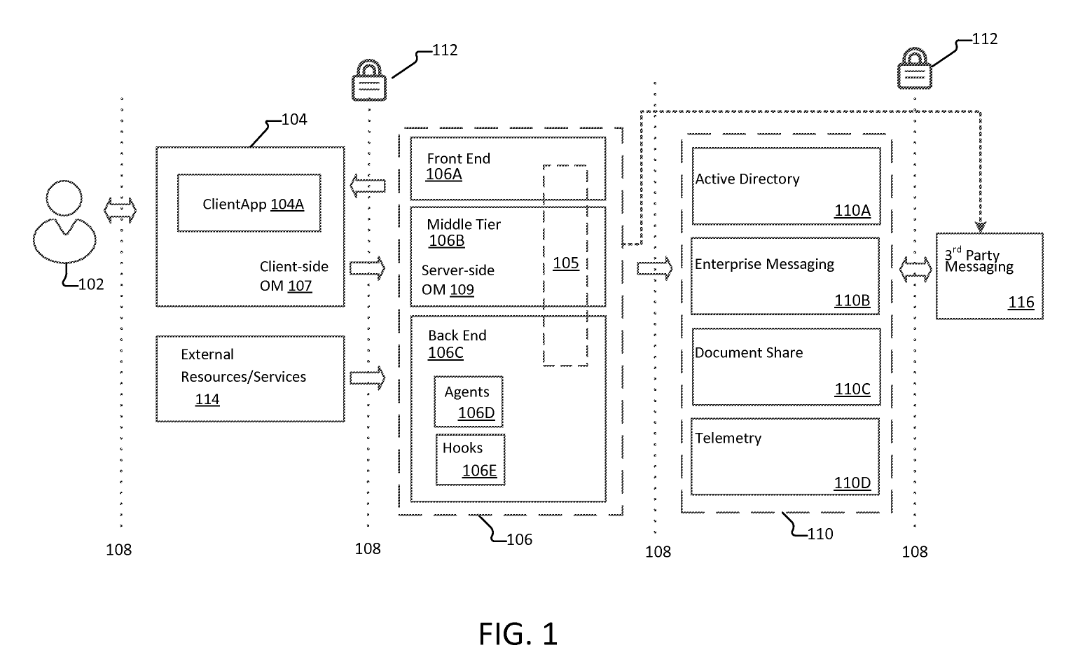

FIG. 1 illustrates an exemplary system for providing a unified communication platform, according to an example embodiment. In aspects, a unified communication platform 105 may be implemented via a client unified communication application 104a executed on client computing device 104 in communication with a server computing device 106. In some aspects, the client computing device 104 may comprise a client-side object model in communication with a server-side object model. In a basic configuration, the client computing device 104 is a personal or handheld computer having both input elements and output elements. For example, the client computing device 104 may be one of including but not limited to: a mobile telephone; a smart phone; a tablet; a phablet; a smart watch; a wearable computer; a personal computer; a desktop computer; a laptop computer; a gaming console/computer device (e.g., Xbox); a television; and the like. This list is exemplary only and should not be considered as limiting. Any suitable client computing device for executing a communication application may be utilized.

The unified communication platform 105 is a communication system/service that provides a collaborative environment for users to communicate and collaborate. The unified communication platform 105 is illustrated by a dashed line, illustrating that implementation of the unified communication platform 105 may involve the front end 106a, middle tier 106b and/or the back end 106c of server 106, among other examples. In aspects, server computing device 106 may include one or more server computing devices 106. In an example the unified communication platform 105 presents a configurable and extensible workspace for collaboration between users through a user interface (UI) that may comprise a plurality of different views. Users of the unified communication platform 105 may be include but are not limited to: one or more persons, companies, organizations, departments, virtual teams, ad-hoc groups, vendors, customers, third-parties, etc. Users of the unified communication platform 105 may have one or more user profiles that are customizable by the user. The unified communication platform 105 enables visibility and communication between users including users who are organized in teams or groups as well as users/groups outside of a team/group. Policies may be set for teams/groups by one or more administrators of a team/group and by administrators of the unified communication platform 105. Examples described throughout the present disclosure are designed to accommodate to protect user privacy. Protection of sensitive information, including legally protected data and personally identifiable information, is a paramount consideration for implementing examples described herein. For instance, users may set privacy settings for what data that can displayed/shared, and examples described herein comply with such settings as well as laws related to distribution of data and protection of privacy.

As illustrated in FIG. 1, systems and/or services associated with the unified communication platform 105 may be implemented as a front end 106a, a middle tier 106b, and a backend 106c on a server computing device 106. However, one skilled in the art will recognize that the unified communication platform 105 may be implemented across one or more components of system examples described herein, including one or more client computing devices 104 and/or enterprise stack 110. In some aspects, the front end 106a of server computing device 106 may send information and commands via the client unified communication application 104a to the client computing device 104. In some aspects, the middle tier 106b and/or the back end 106c of the server computing device 106 may receive information and commands from the client computing device 104 via the client unified communication application 104a. In other aspects, the front end 106a may act as an intermediary between the client computing device 104 and the middle tier 106b. That is, front end 106a may exchange commands and information with the client computing device 104 and may also exchange the commands and information with middle tier 106b. In an example, the unified communication platform 105 refers to a server unified communication application executing on server computing device 106 via front end 106a, middle tier 106b, and a backend 106c in communication with the client unified communication application 104a.

In some aspects, the backend 106c may further comprise or be in communication with one or more application agents 106d to facilitate interoperability and communication with one or more external resources 114. More specifically, application agents 106d may interface with external resources 114 using webhooks 106e in order to facilitate integration between the unified communication platform 105 and external resources/services 114. External resources 114 are any resource (e.g., system, application/service, etc.) that exists and is manageable outside of the unified communication platform 105. External resources include but are not limited to systems, application/services that may be managed by a same organization as the unified communication platform 105 (e.g., other services provided by an organization such as web search services, e-mail applications, calendars, device management services, address book services, informational services, etc.) as well as services and/or websites that are hosted or controlled by third parties. For example, external resources 114 may include line-of-business (LOB) management services, customer relationship management (CRM) services, debugging services, accounting services, payroll services, etc. External resources 114 may further include other websites and/or applications hosted by third parties, such as social media websites; photo sharing websites; video and music streaming websites; search engine websites; sports, news or entertainment websites, and the like. That is, some external resources 114 may provide robust reporting, analytics, data compilation and/or storage service, etc., whereas other external resources 114 may provide search engines or other access to data and information, images, videos, and the like.

In aspects, data or information may be shared between server computing device 106 and the one or more external resources 114. For example, business contacts, sales, etc., may be input via a client computing device 104 in communication with server computing device 106, which is in communication with CRM software that is hosted by a third party. The CRM software may track sales activity, marketing, customer interactions, etc., to provide analytics or other information for promoting business relations. Alternatively, a manufacturing order may be input via a client computing device 104 in communication with server computing device 106, which is in communication with LOB management software that is hosted by a third party. The LOB management software may guide and track the order by creating work flows such as tasks or alerts for scheduling manufacturing equipment, ordering raw materials, scheduling shipping, relieving inventory, etc. In some cases, the LOB management software may create requests for user approval or review at different stages in the work flow. In still further aspect, a user may issue a query to one or more of the external resources 114, such as a request for business contacts, sales for the prior month, the status of an order, a request for an image, etc.

As illustrated by FIG. 1, the server computing device 106 may communicate with external agents 114 and client device 104 via a network 108. In one aspect, the network 108 is a distributed computing network, such as the Internet. In aspects, the unified communication platform 105 may be implemented on more than one server computing device 106, such as a plurality of server computing devices 106. As discussed above, the server computing device 106 may provide data to and from the client computing device 104 through the network 108. The data may be communicated over any network suitable to transmit data. In some aspects, the network 108 is a computer network such as an enterprise intranet and/or the Internet. In this regard, the network 108 may include a Local Area Network (LAN), a Wide Area Network (WAN), the Internet, wireless and wired transmission mediums. In further aspects, server computing device 106 may communicate with some components of the system via a local network (e.g., an enterprise intranet), whereas server computing device 106 may communicate with other components of the system via a wide area network (e.g., the Internet).

According to further aspects, communication between the unified communication platform 105 and other components of the system may require authentication 112. Authentication 112 refers to a process by which a device, application, component, user, etc., provides proof that it is “authentic” or “authorized” to access or communicate with another device, application, component, user, etc. Authentication may involve the use of third-party digital certificates, authentication tokens, passwords, symmetric or asymmetric key encryption schemes, shared secrets, authentication protocols, or any other suitable authentication system or method either now known or developed in the future. In aspects, upon authentication, access or communication may be allowed and data or information may be exchanged between the unified communication platform 105 and various other components of the system. In some aspects, an environment or network linking various devices, applications, components, users, etc., may be referred to as a “trusted” environment. In a trusted environment, authentication between devices, applications, components, users, etc., may be unnecessary.

The unified communication platform 105 executing operations on the server computing device 106 may further be in communication with one or more enterprise applications (e.g., enterprise stack 110). Enterprise stack 110 may include, for example, an active directory 110a, an enterprise messaging application 110b, a file sharing application 110c, a telemetry application 110d, and the like. The enterprise stack 110 may be stored and/or executed locally, e.g., within an enterprise intranet, or in distributed locations over the Internet. In some cases, enterprise stack 110 may be included within server computing device 106. For example, active directory 110a may be included as part of back end 106c of server computing device 106. In at least some instances, enterprise stack 110 may reside or communicate with the unified communication platform 105 within a trusted environment. In aspects, information and/or messages received, sent or stored via the unified communication platform 105 may be communicated to the enterprise stack 110. Moreover, information and/or messages received, sent or stored via the enterprise stack 110 may be communicated to the unified communication platform 105.

Additionally, in some aspects, the unified communication platform 105 executing on the server computing device 106 may be in communication with one or more third party messaging applications 116. Third party messaging applications 116 are messaging applications that are hosted or controlled by third parties. In aspects, some users who are members of a team may be registered with the unified communication platform 105 (e.g., internal users), whereas other users who are members of the team may not be registered with the unified communication platform 105 (e.g., external users) but may be registered with one or more third party messaging applications 116. In some aspects, users who are registered with an enterprise messing application 110b, but not with the unified communication platform 105, are considered external users. In this case, the unified communication platform 105 may communicate with one or more third party messaging applications 116 and/or with one or more enterprise messaging applications 110b to exchange information and messages with the external users. In some aspects, communication between the unified communication platform 105 and the one or more third party messaging applications 116 and/or the one or more enterprise messaging applications 110b over network 108 may involve authentication 112. In other aspects, communication between the unified communication platform 105 and, for example, the one or more enterprise messaging applications 110b, may not involve authentication 112.

As should be appreciated, the various devices, components, etc., described with respect to FIG. 1 are not intended to limit the systems and methods to the particular components described. Accordingly, additional topology configurations may be used to practice the methods and systems herein and/or some components described may be excluded without departing from the methods and systems disclosed herein.

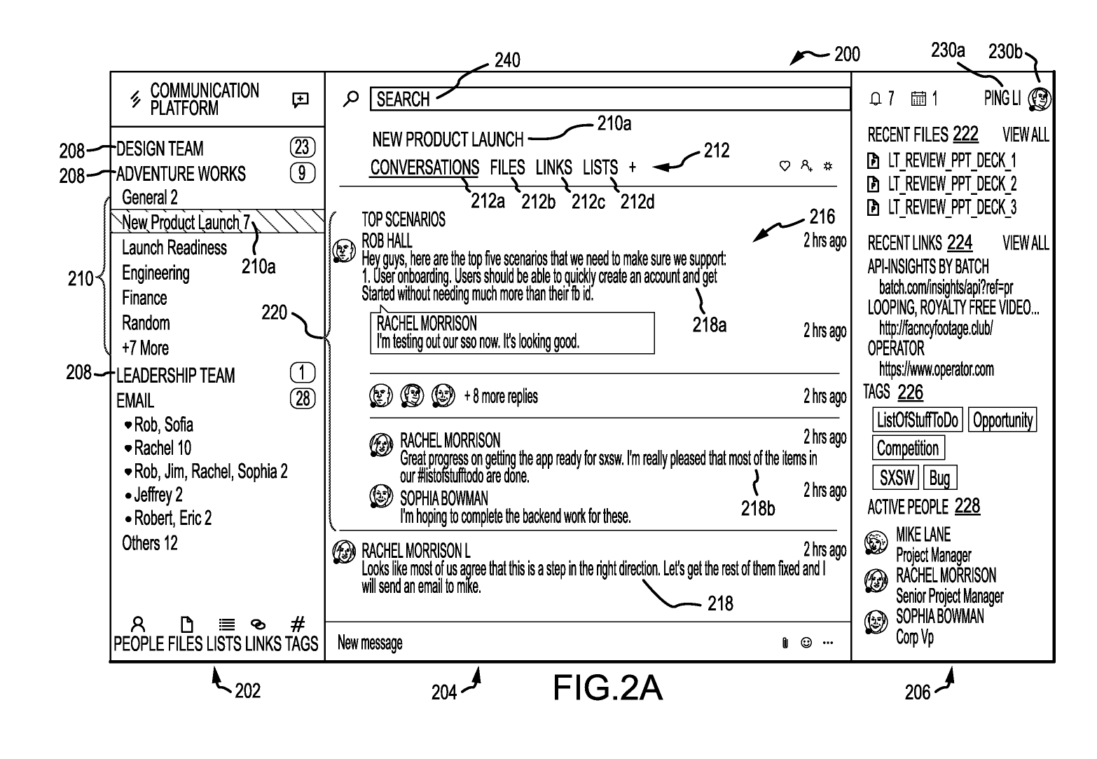

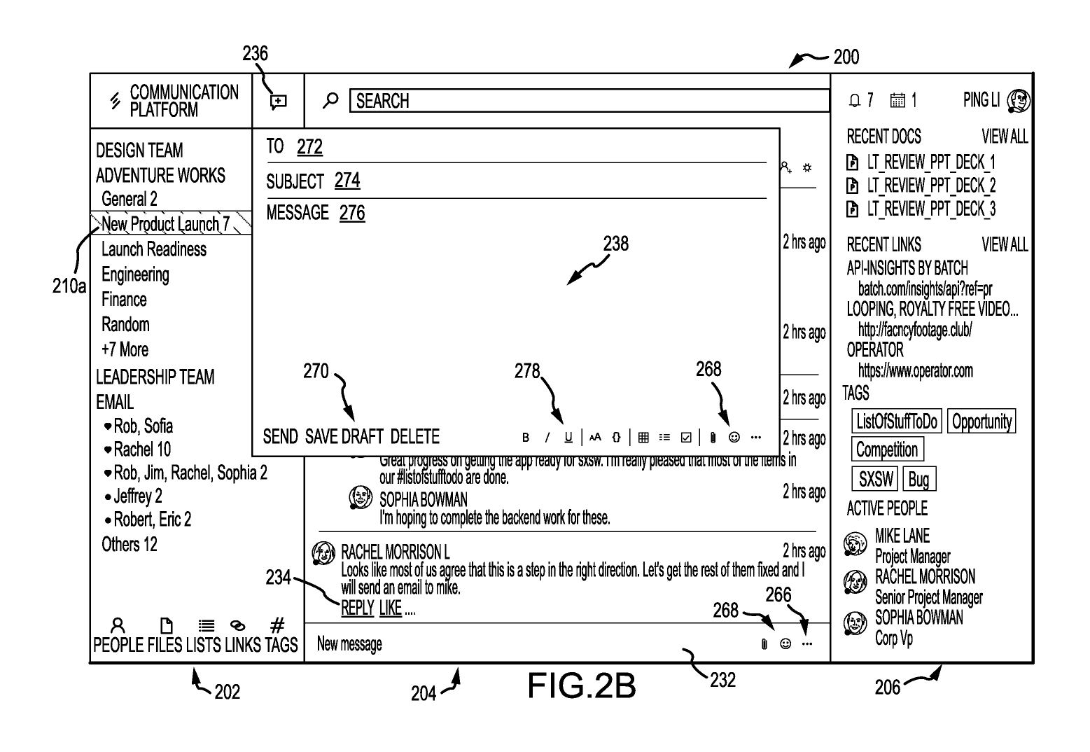

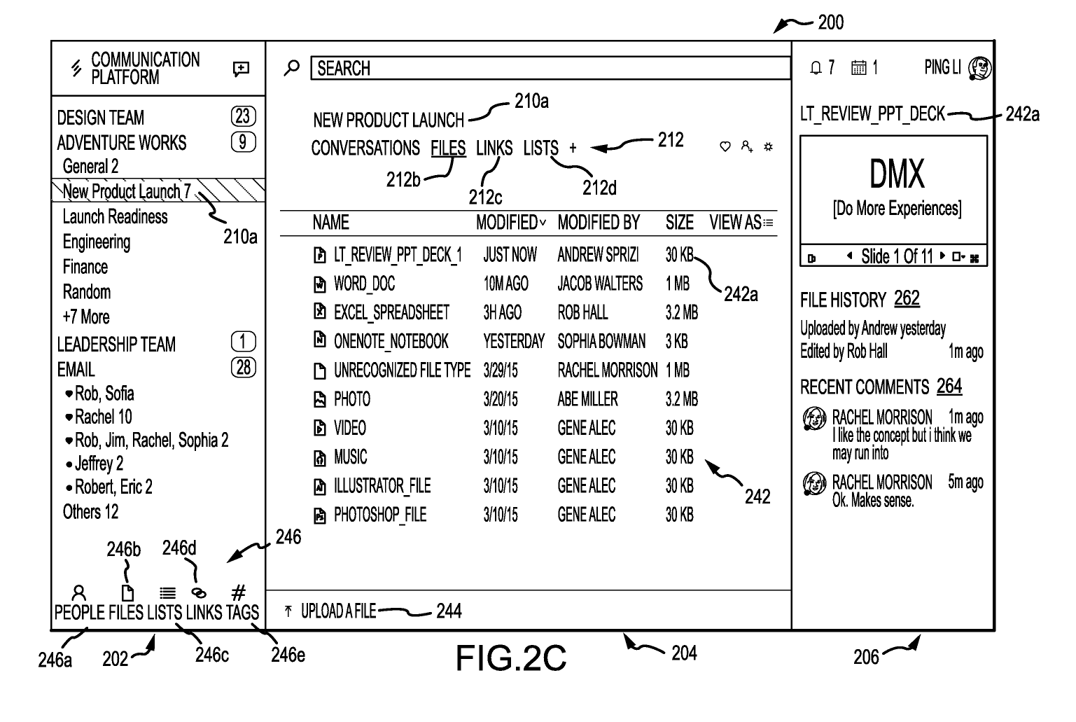

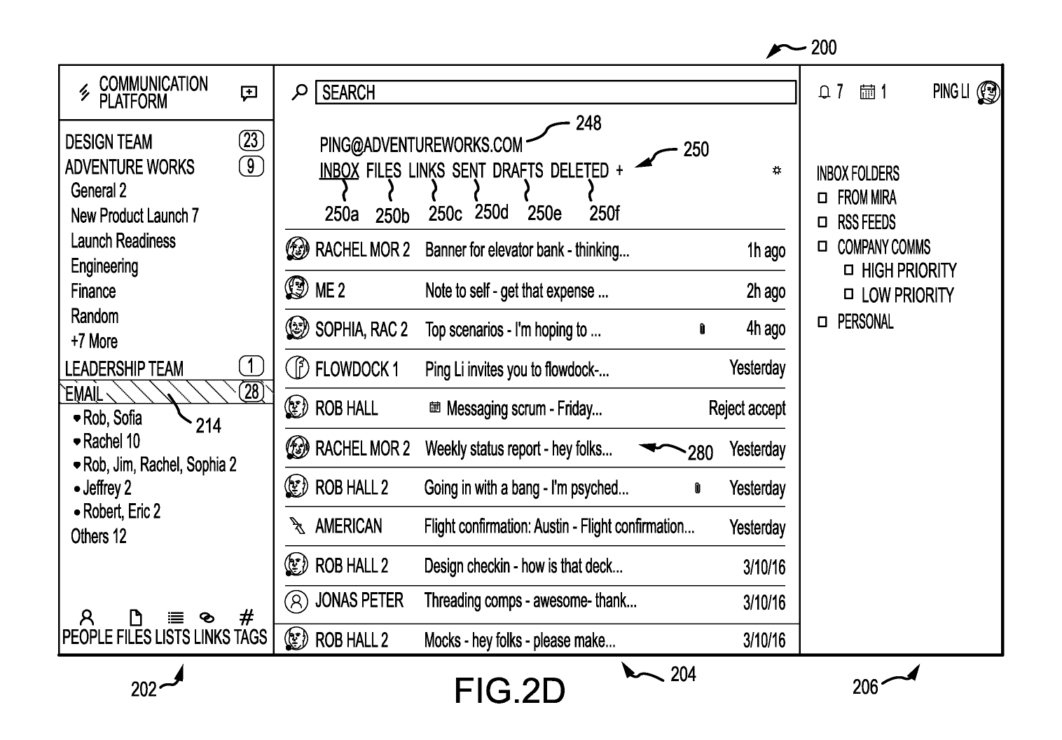

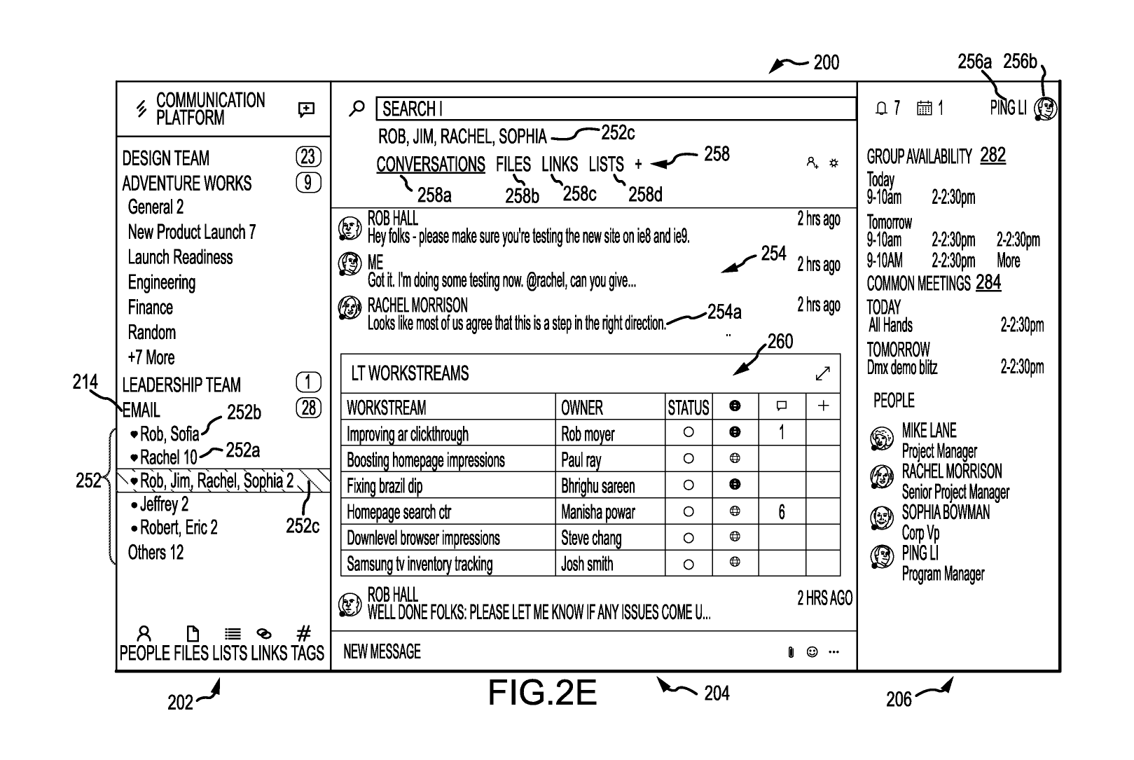

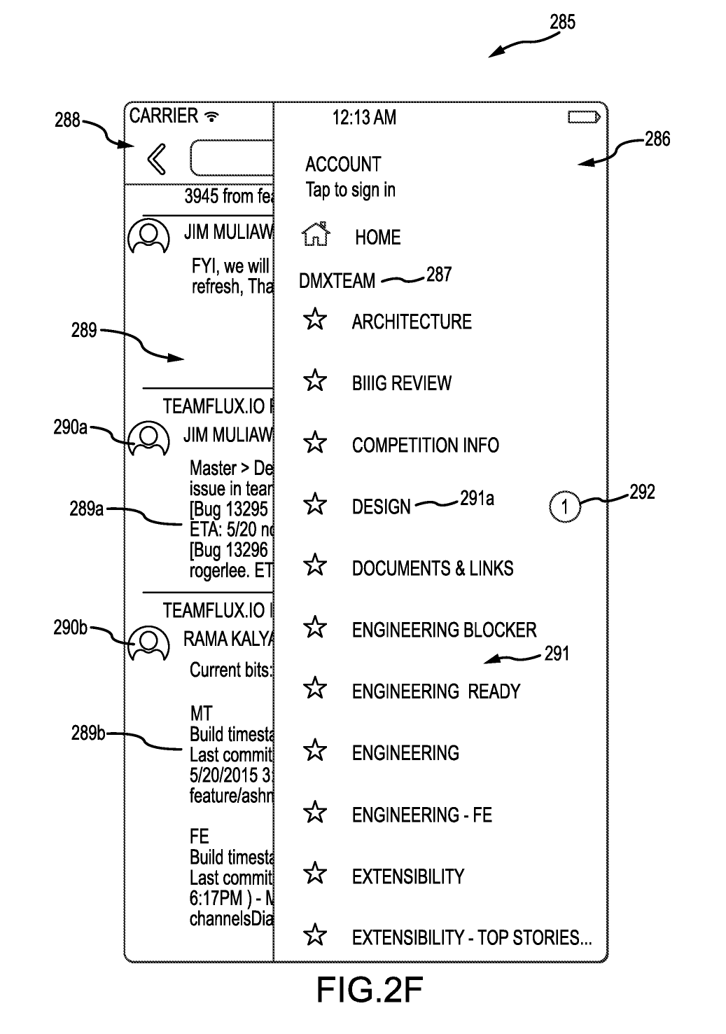

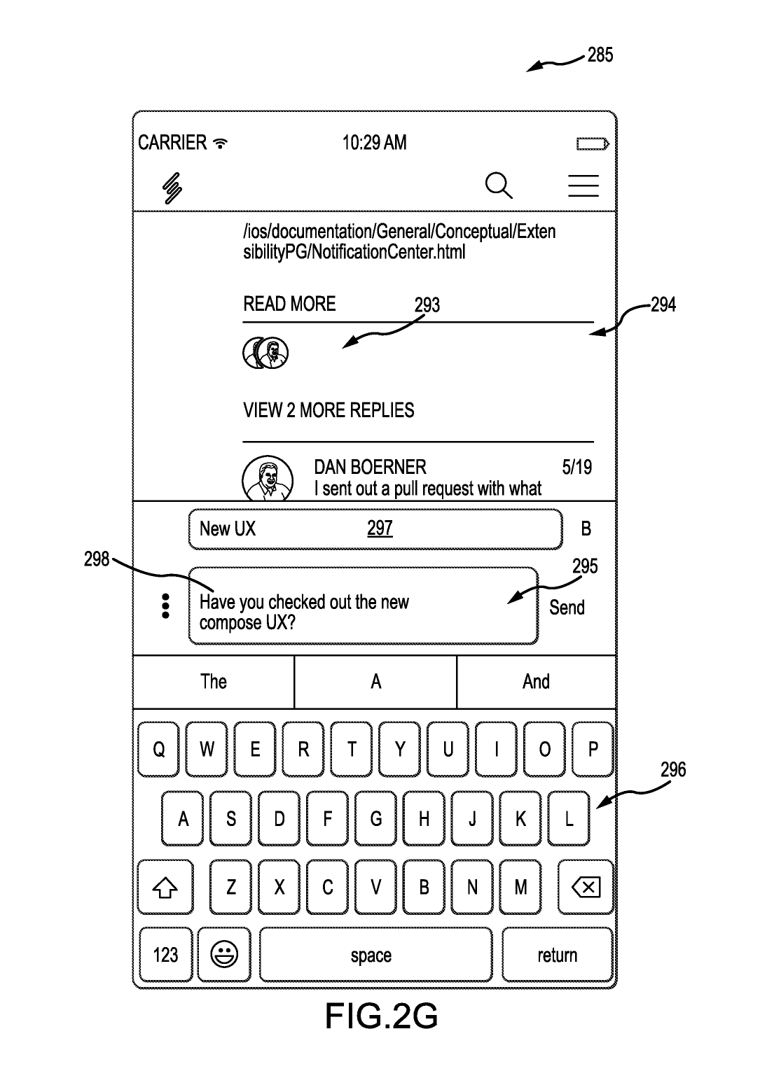

FIG. 2A illustrates an exemplary interface for interacting with the unified communication platform in accordance with examples describe herein.

In aspects, a user may interact with a unified communication platform via a user interface 200, e.g., a graphical user interface. An exemplary unified communication platform 105 is described in the description of FIG. 1 and further described throughout the rest of the present disclosure such as in FIGS. 2A-2E and 5A-6C, among other examples. In some aspects, the user interface 200 may involve one or more panes or windows for organizing the display of information and/or interactive controls. In one example, the user interface 200 may include three panes, e.g., a left rail 202, a center pane 204, and a right rail 206. In another example, the user interface 200 may include two panes, e.g., a left rail and a right rail. In still other examples, the user interface 200 may include one pane, four or more panes, and/or panes may be embodied in multiple browser or application windows.

As detailed above, each pane or window may display information in the form of text, graphics, etc., and/or one or more interactive controls or links. For example, a first pane, e.g., left rail 202, may display one or more teams 208, an email portal, etc. As used herein, a team refers to any group of two or more users formed for a purpose. A team may be formed for any purpose, e.g., a business purpose, a social purpose, a charitable purpose, and the like. Moreover, a team may comprise any type of user, e.g., co-workers, family members, classmates, business associates, and the like. In aspects, a team may be formed within the unified communication platform 105 by creating a team title, e.g., leadership team, design team, event team, project team, etc., and adding users (e.g., members) to the team. For example, in a settings or administration pane (not shown), members may be added to the team by selecting an identifier of a user, e.g., a user icon, a user email, a user phone number, etc. In at least some aspects, each member of a team is granted access to a team portal or channel. In further aspects, any number of teams may be created within the unified communication platform 105 and/or teams may be implicitly created based on communications between two or more users.

A team portal may provide access to all communications, files, links, lists, hashtags, development tools, etc., shared by any member of a team. According to examples, upon selection (e.g., by clicking) of a team title within a pane, e.g., the left rail 202, a team portal may be opened. A team portal refers to an access point through which team members can view and interact with shared information and other team members. In at least some cases, each member of a team is granted full access to the information and conversations shared within the team portal. In aspects, upon selection of a team 208, general information regarding the team, project specifications, etc., may be displayed in a second pane, e.g., center pane 204. For example, member names, member contact information (e.g., email addresses, phone numbers, etc.), member usage time, project specifications, project time lines, project mission, and the like, may be displayed in the center pane 204.

A team portal may be further organized based on categories 210 of information for a team 208. For example, any suitable category 210 for organizing team information may be created for a team portal, e.g., finance, engineering, launch readiness, debugging, catering, construction, general, random, and the like. In aspects, information related to a category 210 may be displayed in center pane 204 upon selecting a category 210 of a team 208 within left rail 202. In some instances, each member of a team is granted full access to information associated with each category 210 of a team 208 within the team portal.

As noted above, a team portal provides access to all communications, files, links, lists, hashtags, etc., shared by members of a team 208. In aspects, within each category 210, information may further be organized by tabs or pages. For example, each tab 212 may display a different type of information associated with a category 210 in the center pane 204. When selected, a tab 212 may be identified by highlighting, with a different font or font color, by outlining, and the like. As illustrated by FIG. 2A, a first tab (e.g., conversations tab 212a) may display communications between team members. In aspects, a conversation 216 entails two or more communications 218 of any type or mode between team members. In some cases, a conversation 216 may be displayed in ascending order with the most recent communication 218 displayed at the bottom of the center pane 204. Alternatively, a conversation 216 may be displayed in descending order with the most recent communication 218 displayed at the top of the center pane 204.

In some cases, described further below, one or more communications 218 may be grouped as a conversation thread 220. A communication 218 refers to a single message transmitted by a team member in any format (e.g., email, text, SMS, instant message, etc.) via any mode (e.g., via the unified communication platform, or via any enterprise or third-party messaging application). That is, messages may be generated within the unified communication platform 105 between internal users or messages may be communicated to and from external users via enterprise messaging applications (e.g., enterprise messaging application 110b) and/or third party messaging applications (e.g., third party messaging applications 116).

As detailed above, each pane or window may display information and/or interactive controls. For example, a third pane, i.e., right rail 206, may display context information, status information, recent activity, and the like. In some aspects, information displayed in the right rail 206 may be related to or associated with the category 210 selected in the left rail 202. For instance, where the central pane 204 displays communications, files, links, lists, hashtags, etc., related to a category 210a entitled “New Product Launch,” the right rail 206 may display one or more recent files 222, recent links 224, tags 226, or active people 228. In some aspects, at least some of the information displayed in the right rail 206 may be specific to a particular user (e.g., the particular user accessing the team portal via a client computing device 104). In aspects, the particular user accessing the team portal may be identified by a name, icon, or the like, within right rail 206. For example, the particular user may be identified by user name 230a or user icon 230b. That is, for example, the recent files 222 and/or recent links 224 may have been recently accessed or uploaded by the particular user. In another example, the right rail 206 displayed for another user accessing the same category 210 may display a different set of recent files 222 or recent links 224. In further examples, additional or different information relevant to a category 210 and a particular user may be displayed in the right rail 206, e.g., user tasks, user alerts, user calendar, user notes, etc.

According to additional aspects, center pane 204 may include a search field 240. For example, search field 240 may allow a user to search within a team portal for any communication, file, link, list, hashtag, term, team member, calendar, task, event, and the like. In aspects, search field 240 may allow for plain language searching, Boolean searching (e.g., searching using Boolean operators), or otherwise. Upon entering one or more search terms into the search field 240, any information related to the search terms within the team portal may be displayed as search results to the user.

As should be appreciated, the various features and functionalities of user interface 200 described with respect to FIG. 2A are not intended to limit associated systems and methods to the particular features and functionalities described. Accordingly, additional features and functionalities may be associated with the systems and methods described herein and/or some features and functionalities described may be excluded without departing from the systems and methods described herein.

FIG. 2B illustrates an exemplary interface for interacting with the unified communication platform in accordance with examples describe herein.

As illustrated by FIG. 2B, the unified communication platform 105 may provide a variety of options for generating communications. For example, the unified communication platform 105 may provide an input entry field 232, for sending an instant message, SMS, or other “text-like” communication. However, one skilled in the art will recognize that the input entry field 232 is not limited to text-like input. In aspects, an input entry field 232 may allow entry of text, entry of commands, entry of hashtags, and/or teams may be implicitly created based on communications between two or more users, etc. The input entry field 232 may receive input entry in any form including but not limited to text input, audio/speech input, handwritten input, and signals, among other examples. Input entry field 232 may further include controls 266 for attaching files, inserting emoticons, etc. However, in at least some aspects, the input entry field 232 may not provide for selection of recipients or entry of a subject line. Upon inputting a message into an input entry field 232 and hitting enter, a communication from a user may automatically post to a conversation as a new message. According to further aspects, an input entry field 232 may include optional controls 266 for expanding the input entry field 232 into an email interface object (e.g., email interface object 238 described below).

Alternatively, the unified communication platform 105 may provide a reply link 234 associated with each communication 218 of a conversation. In some aspects, reply link 234 is displayed near each communication 218 of a conversation, e.g., to the right of a sender or subject line for a communication (not shown), indented below a communication (shown), up and to the right of a communication (not shown), and the like. Alternatively, reply link 234 may not be displayed unless and until a communication 218 is clicked, hovered over, touched or otherwise identified with an input device (e.g., mouse, pointer, etc.). Upon display and selection of a reply link 234 associated with a particular communication 218, a reply message text field may be displayed (not shown). Similar to the input entry field 232, the reply message text field may allow entry of text, entry of commands, entry of hashtags, attachment of files, insertion of emoticons, etc. However, in this case, upon inputting a message and hitting enter, a communication from the user may automatically post within a conversation thread 220 associated with the particular communication 218. In aspects, as illustrated by FIG. 2A, communications 218b within a conversation thread 220 may be displayed as indented, bulleted, or otherwise offset below a primary or initial communication 218a (in above example, the particular communication may be referred to as a primary communication).

Alternatively still, the unified communication platform 105 may provide an email control 236 for accessing an email interface object, e.g., email interface object 238, to send “email-like” communications. In aspects, email interface object 238 may allow similar actions to input entry field 232, such as a text field 276 for entry of text, entry of commands, entry of hashtags, etc., and controls 268 for attachment of files, insertion of emoticons, etc. Additionally, email interface object 238 may provide controls 278 for altering text font and size, bulleting text, etc., and controls 270 for sending, saving a draft email, deleting, etc. Email interface object 238 may further provide a recipient field 272 for inputting or selecting recipients and a subject field 274 for inputting a subject line, and the like. Upon inputting a message into an email interface object 238 and hitting enter, a communication from the user may automatically post to the conversation as a new “email-like” message.

As should be appreciated, the various features and functionalities of user interface 200 described with respect to FIG. 2B are not intended to limit associated systems and methods to the particular features and functionalities described. Accordingly, additional features and functionalities may be associated with the systems and methods described herein and/or some features and functionalities described may be excluded without departing from the systems and methods described herein.

FIG. 2C illustrates an exemplary interface for interacting with the unified communication platform in accordance with examples describe herein.

As described above, each tab 212 may display a different type of information associated with a category 210a in the center pane 204. For example, as illustrated by FIG. 2C, a second tab (e.g., file tab 212b) may display files 242 shared between team members. Files 242 may include any type of file, e.g., document files, spreadsheet files, presentation files, image files, video files, audio files, note files, and the like.

In some aspects, files 242 displayed in file tab 212b include files 242 that were sent as attachments to communications 218 between team members. That is, the unified communication application may extract files sent as attachments and automatically save them in file tab 212b. In other aspects, as illustrated by FIG. 2C, a file upload field 244 may be provided. Upon selecting file upload field 244, one or more files 242 may be saved to the file tab 212b by a user. For example, upon selection of file upload field 244, a browsing box (not shown) may be activated for retrieving a file for upload. Alternatively, a command may be entered (e.g., /file) for retrieving a file for upload. Alternatively still, a file may be copied and pasted into file upload field 244. In aspects, any suitable method for uploading and saving a file to the file tab 212b may be implemented. In at least some aspects, a single version of a first file with a first file name exists in file tab 212b such that revisions, edits, annotations, etc., made to the first file are synchronized and stored within the single version. In further aspects, upon saving the first file with a second file name, a second file can be created, attached, and/or uploaded to file tab 212b.

According to further aspects, a third tab (e.g., link tab 212c) may display links shared between team members. In some aspects, links displayed in the link tab 212c include links that were sent as attachments to communications 218 between team members. That is, the unified communication application may extract links sent as attachments and automatically save them to the link tab 212c. In other aspects, a link upload field (not shown) may be provided. Upon selecting a link upload field, one or more links may be saved to the link tab 212c by a user. For example, upon selection of a link upload field, a browsing box (not shown) may be activated for retrieving a link for upload. Alternatively, a command may be entered (e.g., /link) for retrieving a link for upload. Alternatively still, a link may be copied and pasted into the link upload field. In aspects, any suitable method for uploading and saving a link to the link tab 212c may be implemented.

A fourth tab (e.g., list tab 212d) may display list files or other information, data, objects, images, etc., shared between team members. In aspects, list files may include lists, tables, charts, or other organized forms of data. In some aspects, list files displayed in list tab 212d include list files that were sent as attachments to communications 218 between team members. That is, the unified communication application may extract list files sent as attachments and automatically save them to list tab 212d. In other aspects, a list may be created or uploaded by a user within list tab 212d. For example, a list creation control (not shown) may be provided for creating a list file. Upon selecting the list creation control, a list file may be created and saved to the list tab 212d by a user. Alternatively, a list upload field (not shown) may be provided. Upon selecting a list upload field, one or more list files may be saved to the list tab 212d by a user, as described similarly above. In at least some cases, a single copy of each list file may exist such that if data is updated in any view, e.g., within the communications tab 212a or the list tab 212d, the list file is automatically updated and synchronized across all other views.

According to aspects, any number of tabs 212 may be created for organizing and sequestering various information related to a category 210a. For example, a hashtag tab may be added to store various hashtags created within communications between team members. In additional examples, custom or extensibility tabs may be created, e.g., a tab for a spreadsheet dashboard, a tab for a webpage, a tab for a custom application, a tab for a system plugin, and the like. In further aspects, additional interactive controls or links (e.g., controls 246) may be provided in left rail 202 for accessing communications, files, lists, links, tags, etc., related to a team 208. For example, control 246a may access team members and/or conversations stored in the team portal, control 246b may access files stored in the team portal, control 246c may access lists stored in the team portal, control 246d may access links stored in the team portal, and control 246e may access hashtags stored in the team portal. In some aspects, selection of a control 246 may display a corresponding tab view within the center pane 204.

As illustrated by FIG. 2C, upon selection of a file tab 212b, the right rail 206 may display different information than when another tab 212 is viewed in center pane 204. For example, highlighting a file 242a in center pane 204 may cause information related to file 242a to be displayed in the right rail 206. For instance, a file history 262 for the file 242a may be displayed in the right rail 206. The file history 262 may include information such as a user identifier for a user who uploaded the file 242a, a user who authored the file 242a, a user who edited the file 242a, a file creation date, a file revision date, and the like. The right rail 206 may further display recent comments 262 regarding file 242a. In aspects, any information related to file 242a may be displayed in right rail 206.

As should be appreciated, the various features and functionalities of user interface 200 described with respect to FIG. 2C are not intended to limit associated systems and methods to the particular features and functionalities described. Accordingly, additional features and functionalities may be associated with the systems and methods described herein and/or some features and functionalities described may be excluded without departing from the systems and methods described herein.

FIG. 2D illustrates an exemplary interface for interacting with the unified communication platform in accordance with examples describe herein.

In further aspects, the left rail 202 may further include an email portal 214. Unlike a team portal, email portal 214 may be an access point through which a particular user can view and interact with his or her email messages. In aspects, upon selection of email portal 214, a second pane, e.g., center pane 204, may display a user's email messages. Center pane 204 may further display a user identifier 248 as a header, e.g., a user email address, a user name, a user icon, and the like. Center pane 204 may provide one or more tabs 250 for organizing the user's email messages. Tabs 250 may include, for instance, an inbox tab 250a, a file tab 250b, a link tab 250c, a sent tab 250d, a drafts tab 250e, a deleted tab 250f, and the like. For example, a user's inbox of messages may be displayed in the center pane 204 at inbox tab 250a. In further aspects, the user's inbox of messages may include all messages sent to the user, e.g., messages between team members, including internal and external users, as well as messages between entities and users that are not team members.

In some aspects, the user's email messages 280 in inbox tab 250a may be displayed in a summary list format (shown) in descending order based on a date the email message was received with the most recent email message displayed at the top of center pane 204. The summary list format may display a portion of each email message, e.g., a sender, a subject line, and a portion of text for each email message.

In alternative aspects, the user's email messages in inbox tab 250a may be displayed in a conversation thread format (not shown). A conversation thread format may display email messages which are replies to a primary email message as indented, bulleted, or otherwise offset below a primary email message. In at least some aspects, each conversation thread may be displayed in descending order based on a date the last email message in the conversation thread was received with the most recent conversation thread displayed at the top of center pane 204. In this case, individual communications (i.e., communications that have not been replied to) may be interspersed among conversation threads in descending order based on a date the individual communication was received. In other aspects, each conversation thread may be displayed in ascending order based on a date the last email message in the conversation thread was received with the most recent conversation thread displayed at the bottom of center pane 204. In this case, individual communications may be interspersed among conversation threads in ascending order based on a date the individual communication was received.

In further aspects, email messages that have been opened or viewed may be displayed within the in inbox tab 250a of center pane 204 with normal text, whereas email messages that have not been opened or viewed may be displayed within the center pane 204 with at least portions of the email message in bold text (e.g., a sender and/or a subject line may be displayed with bold text).

As should be appreciated, the various features and functionalities of user interface w200 described with respect to FIG. 2D are not intended to limit associated systems and methods to the particular features and functionalities described. Accordingly, additional features and functionalities may be associated with the systems and methods described herein and/or some features and functionalities described may be excluded without departing from the systems and methods described herein.

FIG. 2E illustrates an exemplary interface for interacting with the unified communication platform in accordance with examples describe herein.

As described above, upon selection of email portal 214, center pane 204 may display a user's email messages. In some aspects, as illustrated by FIG. 2E, a user's email messages may be organized based on conversations 252 between one or more users. For example, a conversation 252a between a first user and a second user (e.g., Rachel) may be displayed separately from a conversation 252b between the first user, a third user (e.g., Rob) and fourth user (e.g., Sofia).

In aspects, by selecting a conversation 252 displayed in the left rail 202, communications between the one or more users may be displayed in center pane 204. As illustrated in FIG. 2E, conversation 252c has been selected and the communications 254 between the first user and the second user (e.g., Rachel), the third user (e.g., Rob), a fifth user (e.g., Jim), and a sixth user (e.g., Sophia) are displayed in center pane 204. In this example, the first user refers to the particular user accessing the unified communication application (e.g., Ping Li) identified by user name 256a and user icon 256b.

In aspects, communications 254 of conversation 252c may be displayed in descending order based on a date each communication 254 was received with the most recent communication 254 displayed at the top of center pane 204. In other aspects, communications 254 of conversation 252c may be displayed in ascending order based on a date each communication 254 was received with the most recent communication 254 displayed at the bottom of center pane 204.

In further aspects, information related to conversation 252c may be organized by tabs or pages. For example, each tab 258 may display a different type of information associated with conversation 252c in the center pane 204. When selected, a tab 258 may be identified by highlighting, with a different font or font color, by outlining, and the like. As illustrated by FIG. 2E, a first tab (e.g., conversations tab 258a) may display the communications 254 between the first user, second user, third user, fifth user and sixth user. Additional tabs, described in further detail above, may include a second tab (e.g., file tab 258b), a third tab (e.g., link tab 258c), a fourth tab (e.g., list tab 258d), and the like. For example, as illustrated by FIG. 2E, a list 260 was inserted in communication 254a from the second user (e.g., Rachel). In aspects, as described above, the list 260 may be accessed from the conversation tab 258a or from the list tab 258d.

As illustrated by FIG. 2E, when viewing a conversation 252c between the first user, second user, third user, fifth user and sixth user, the right rail 206 may display information associated with the conversation 252c and/or the users participating in the conversation 252c. For example, the right rail 206 may display group availability 282 for the users participating in the conversation 252c. The right rail 206 may further display common meetings 284 between the users participating in the conversation 252c. In aspects, any information related to conversation 252c and/or the participating users may be displayed in right rail 206.

As should be appreciated, the various features and functionalities of user interface 200 described with respect to FIG. 2E are not intended to limit associated systems and methods to the particular features and functionalities described. Accordingly, additional features and functionalities may be associated with the systems and methods described herein and/or some features and functionalities described may be excluded without departing from the systems and methods described herein.

FIG. 2F illustrates an exemplary mobile interface for interacting with the unified communication platform, according to examples described herein.

In aspects, a version of the unified communication platform may provide a user interface 285 for mobile devices. The mobile user interface 285 may provide one or more panes or windows for viewing communications, files, lists, links, etc., associated with one or more teams of which a user is a member. In some aspects, a second pane may be displayed (e.g., second pane 288) upon swiping a first pane (e.g., first pane 286) in a left-to-right direction or a right-to-left direction. One skilled in the art will recognize that actions associated with changing panes (e.g. first pane 286 and second pane 288) are not limited to swiping and may be any input action that is understood by the unified communication platform.

As illustrated, first pane 286 displays one or more teams (e.g., team 287) and one or more categories (e.g., categories 291). In aspects, a notification (e.g., notification 292) may be displayed near a category (e.g., category 291a) when a new communication, file, list, hyperlink, etc., has been received within the category 291. As further illustrated, second pane 288 displays one or more communications 289 (e.g., communications 289a and 289b), which are each associated with a sender (e.g., senders 290a and 290b).

As should be appreciated, the various features and functionalities of user interface 285 described with respect to FIG. 2F are not intended to limit associated systems and methods to the particular features and functionalities described. Accordingly, additional features and functionalities may be associated with the systems and methods described herein and/or some features and functionalities described may be excluded without departing from the systems and methods described herein.

FIG. 2G illustrates an exemplary mobile interface for interacting with the unified communication platform, according to examples described herein.

As described above, mobile user interface 285 may allow a user to view a conversation (e.g., conversation 293) in a conversation pane (e.g., conversation pane 294). The mobile user interface 285 may further provide a new message input field 295 and an input interface 296 for inputting and sending communications to participants of the conversation 293. In aspects, when a communication is sent to the participants of an ongoing conversation (e.g., conversation 293), new message input field 295 does not require recipient information but may provide a subject input field, e.g., subject input field 297, for inputting a subject of the communication, e.g., “New UX.” In some aspects, new message input field 295 may be similar to an instant, chat, SMS, or similar communication interface. In other aspects, new message input field 295 may provide functionality similar to an email communication interface (e.g., allowing for attaching documents, list objects, images, etc.). As illustrated, a communication 298 has been partially input into new message input field 295.

As should be appreciated, the various features and functionalities of user interface 285 described with respect to FIG. 2G are not intended to limit associated systems and methods to the particular features and functionalities described. Accordingly, additional features and functionalities may be associated with the systems and methods described herein and/or some features and functionalities described may be excluded without departing from the systems and methods described herein.

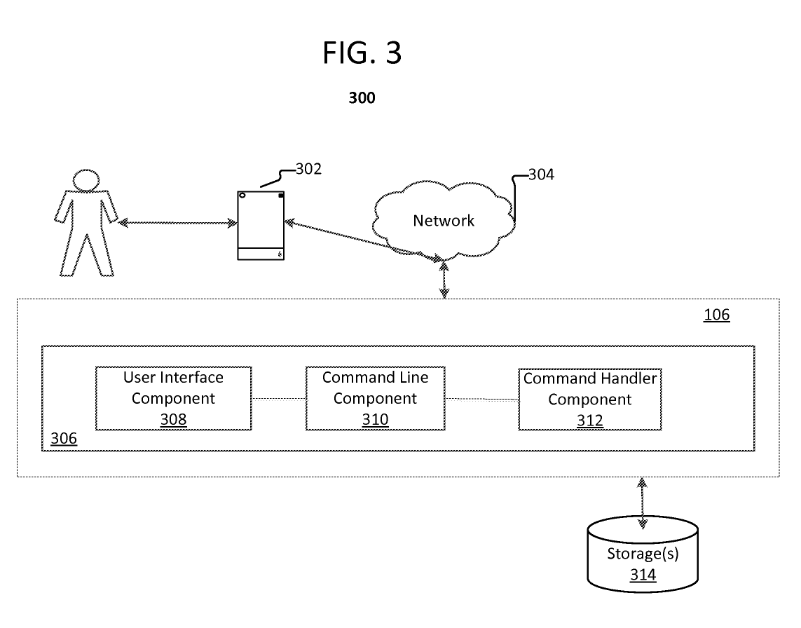

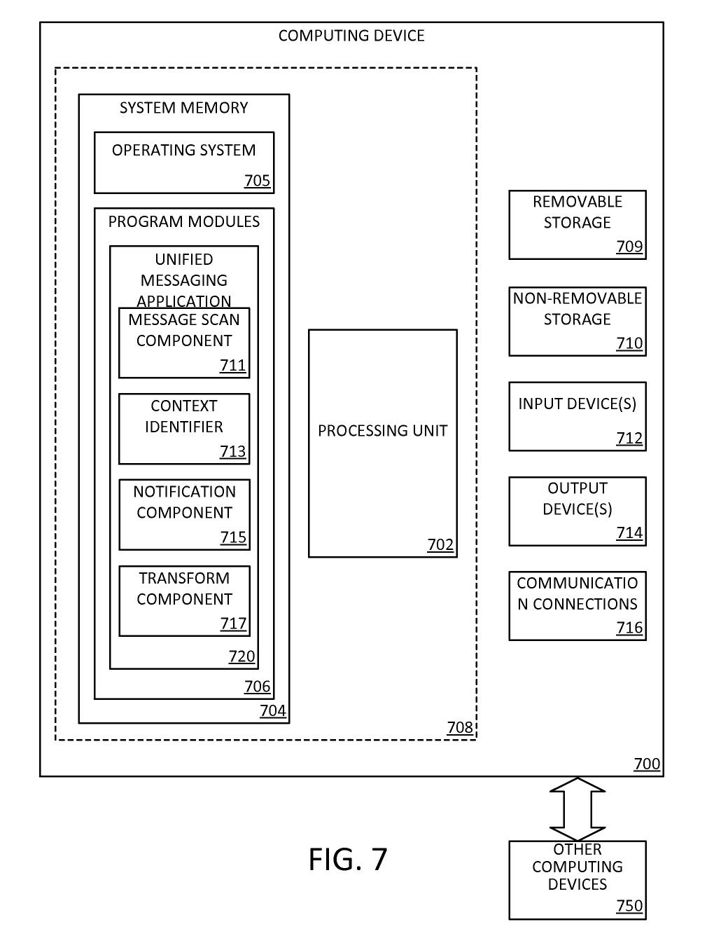

FIG. 3 illustrates an exemplary system 300 implemented on a computing device for command line interaction, according to examples described herein. Exemplary system 300 presented is a combination of interdependent components that interact to form an integrated whole for learned program generation based on user example operations. Components of system 300 may be hardware components or software implemented on and/or executed by hardware components of system 300. In examples, system 300 may include any of hardware components (e.g., ASIC, other devices used to execute/run operating system (OS)), and software components (e.g., applications, application programming interfaces, modules, virtual machines, runtime libraries, etc.) running on hardware. In one example, an exemplary system 300 may provide an environment for software components to run, obey constraints set for operating, and makes use of resources or facilities of the system 100, where components may be software (e.g., application, program, module, etc.) running on one or more processing devices. For instance, software (e.g., applications, operational instructions, modules, etc.) may be run on a processing device such as a computer, mobile device (e.g., smartphone/phone, tablet) and/or any other electronic devices. As an example of a processing device operating environment, refer to operating environments of FIGS. 7-10. In other examples, the components of systems disclosed herein may be spread across multiple devices. For instance, input may be entered on a client device (e.g., processing device) and information may be processed or accessed from other devices in a network such as one or more server devices.

One of skill in the art will appreciate that the scale of systems such as system 300 may vary and may include more or fewer components than those described in FIG. 3. In some examples, interfacing between components of the system 300 may occur remotely, for example where components of system 300 may be spread across one or more devices of a distributed network. In examples, one or more data stores/storages or other memory are associated with system 100. For example, a component of system 300 may have one or more data storages/memories/stores associated therewith. Data associated with a component of system 300 may be stored thereon as well as processing operations/instructions executed by a component of system 300.

System 300 comprises a processing device 302, a network connection 304, command processing components 306 and storage(s) 314. The command processing components 306 may comprise one or more additional components such as user interface component 308, command line component 310 and command handler component 312. As an example the command processing components 306 including sub-components 308-312, may be included in the server computing device 106 of FIG. 1. In one example, the command processing components 306 may be implemented upon any portion of the server computing device 106 including the front-end 106A, the middle tier 106B, and the back-end 106C. However, one skilled in the art will recognize that devices that execute processing performed by the command processing components 306 may vary and can be executed on processing devices aside from the server computing device 106. Components and operations described in system 300 may be associated with the unified communication platform 105 described in FIG. 1.

Processing device 302 may be any device comprising at least one processor and at least one memory/storage. Examples of processing device 302 may include but are not limited to: mobile devices such as phones, tablets, phablets, slates, laptops, watches, computing devices including desktop computers, servers, etc. In one example processing device 302 may be a device of a user that is running an application/service associated with the collaborative communication system. For instance, processing device 302 may be a client device that interfaces with other components of system 300 such as server computing device 106 that may comprise command processing components 306. In examples, processing device 302 may communicate with command processing components 306 via a network 304. In one aspect, network 304 is a distributed computing network, such as the Internet.

The command processing components 306 are a collection of components that are used for command line processing to enable command input to be entered and processed during an interaction with a user of a collaborative communication system/service. Command processing components 306 comprise the user interface component 308. The user interface component 308 is one or more components that are configured to enable interaction with a user of the collaborative communication system/service. Transparency and organization are brought to users of the collaborative communication system/service through the user interface component 308 where a configurable and extensible workspace for collaboration is provided with a plurality of different views, features and customizable options. Examples of the user interface component 308 are shown in FIGS. 2A-2E and 5A-6C. The command line component 310 and the command handler component 312 interface with the user interface component 308 to enable command line processing and interaction with both users and external resources. In one example, the user interface component 308 is implemented as front end 106a of the server computing device 106 and communicates with the middle tier 106b and backend 106c of the server computing device 106 to facilitate user interaction. However, one skilled in the art will recognize that any processing device can be configured to perform specific operations of the user interface component 308. In some aspects, the user interface component 308 may send/receive information and commands via a client unified communication application to a client computing device. In other aspects, the user interface component 308 may act as an intermediary between a client computing device 104 and server computing device 106, for example, the middle tier 106b. That is, the user interface component 308 may exchange commands and information with a client computing device and may also exchange the commands and information with one or more components of the server computing device 106. In examples of system 300, the user interface component 308 may communicate with at least one storage 314 to enable display and processing of a UI associated with the collaborative communication system/service.

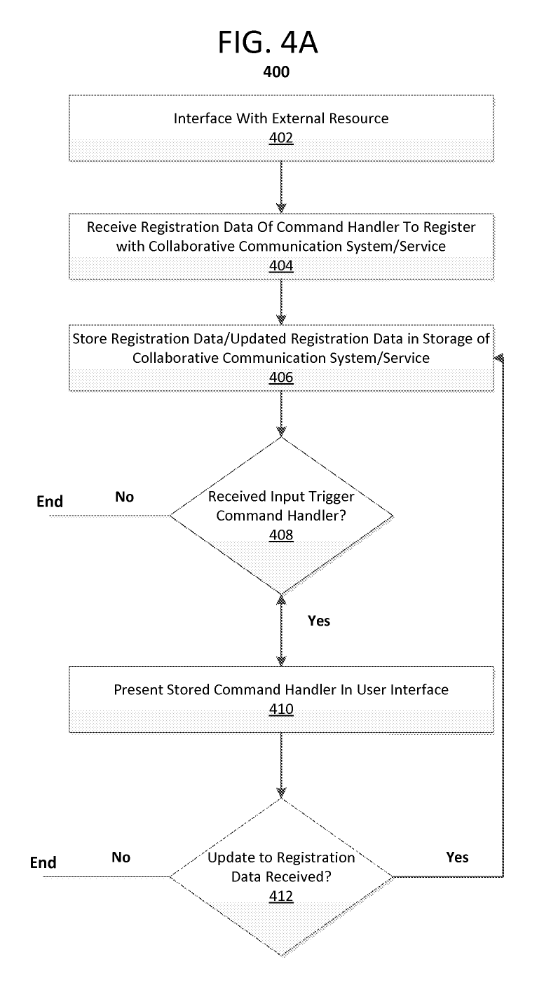

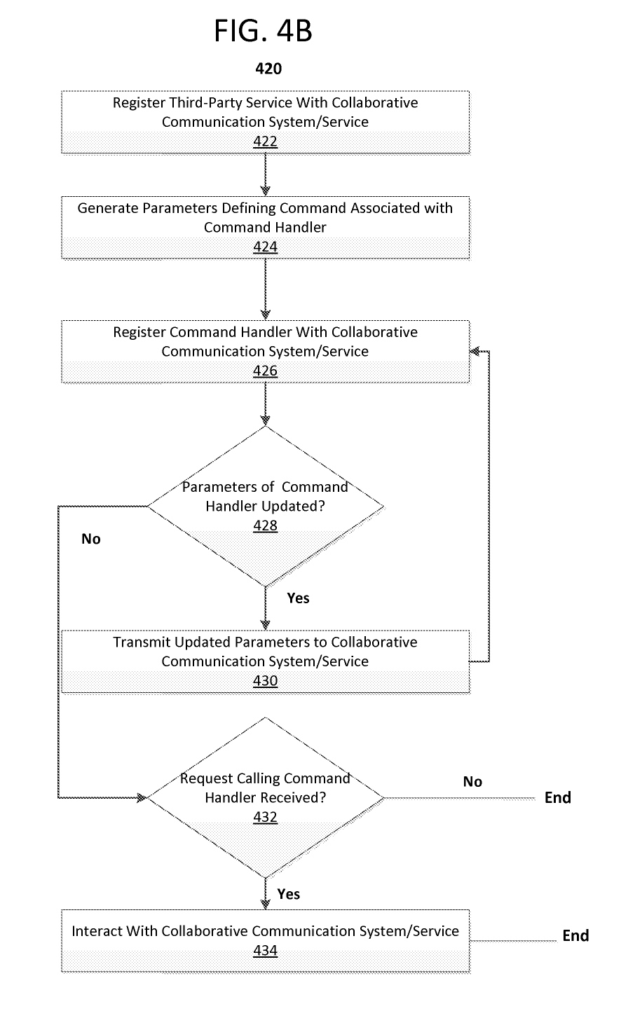

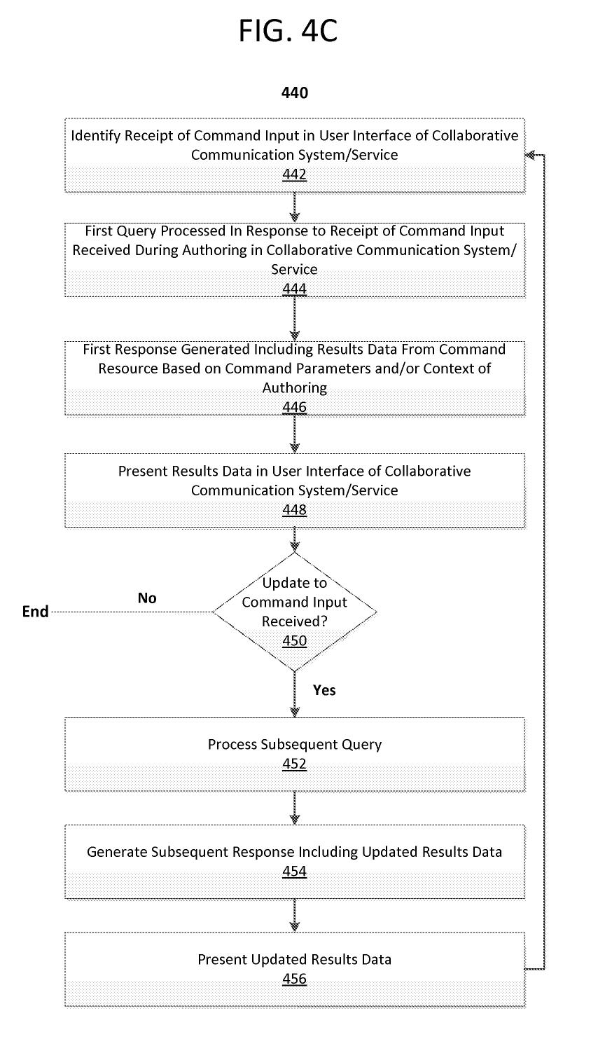

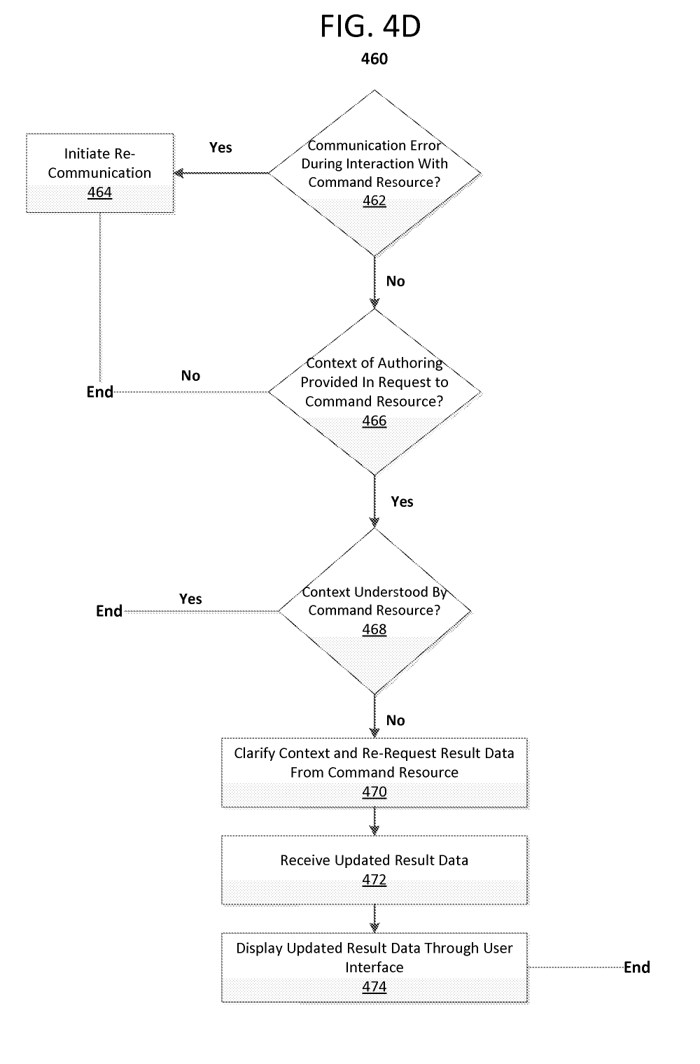

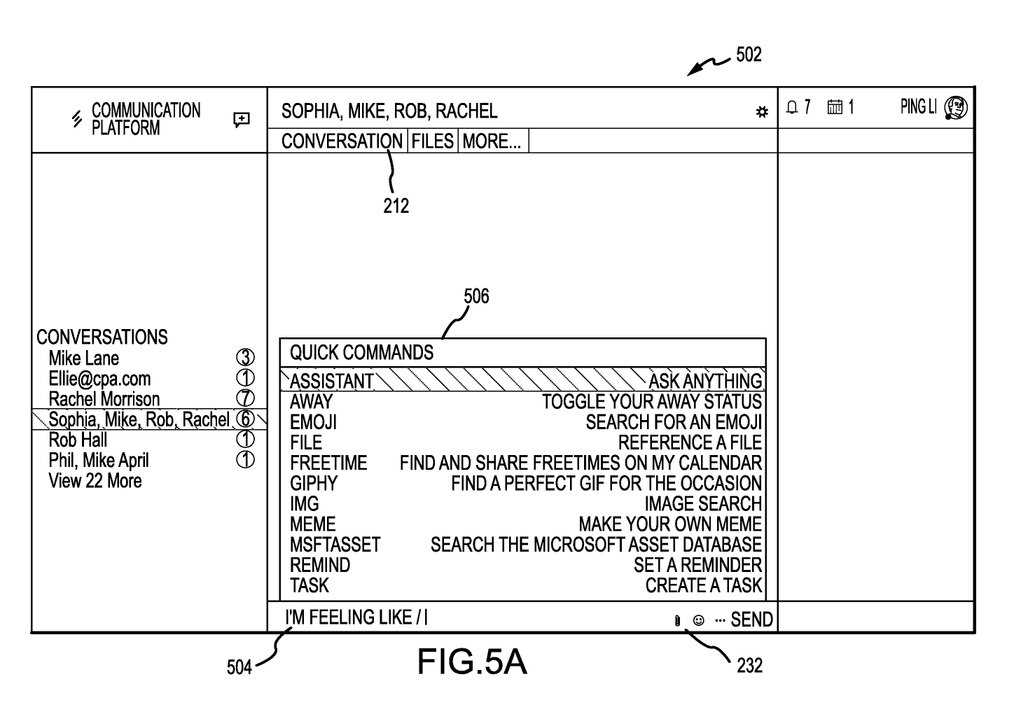

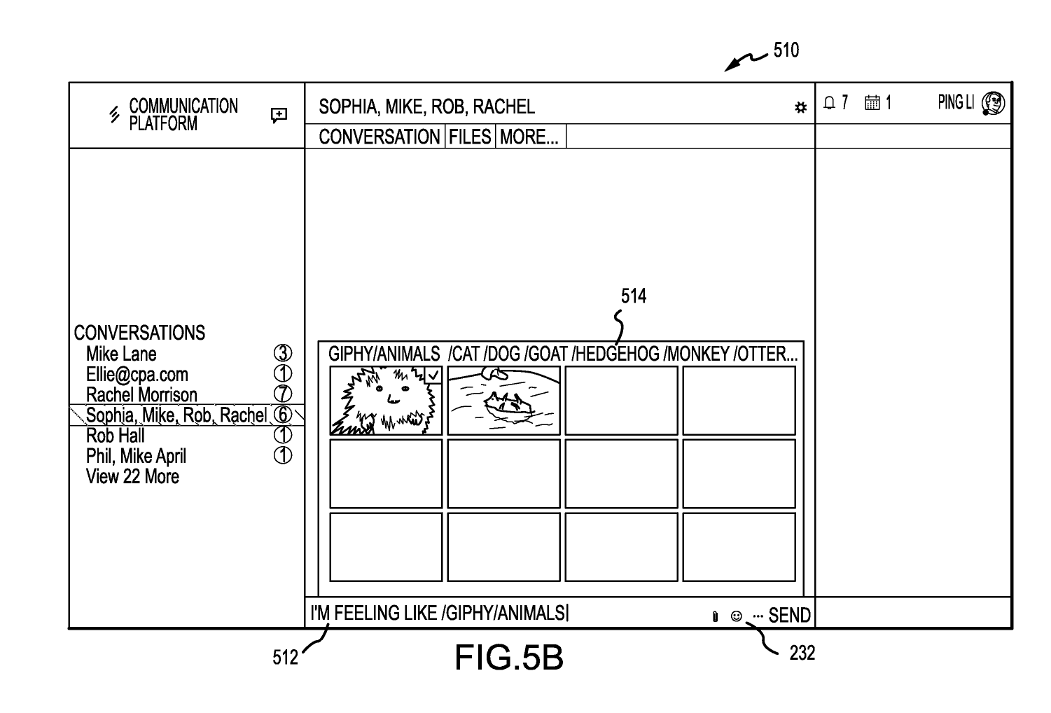

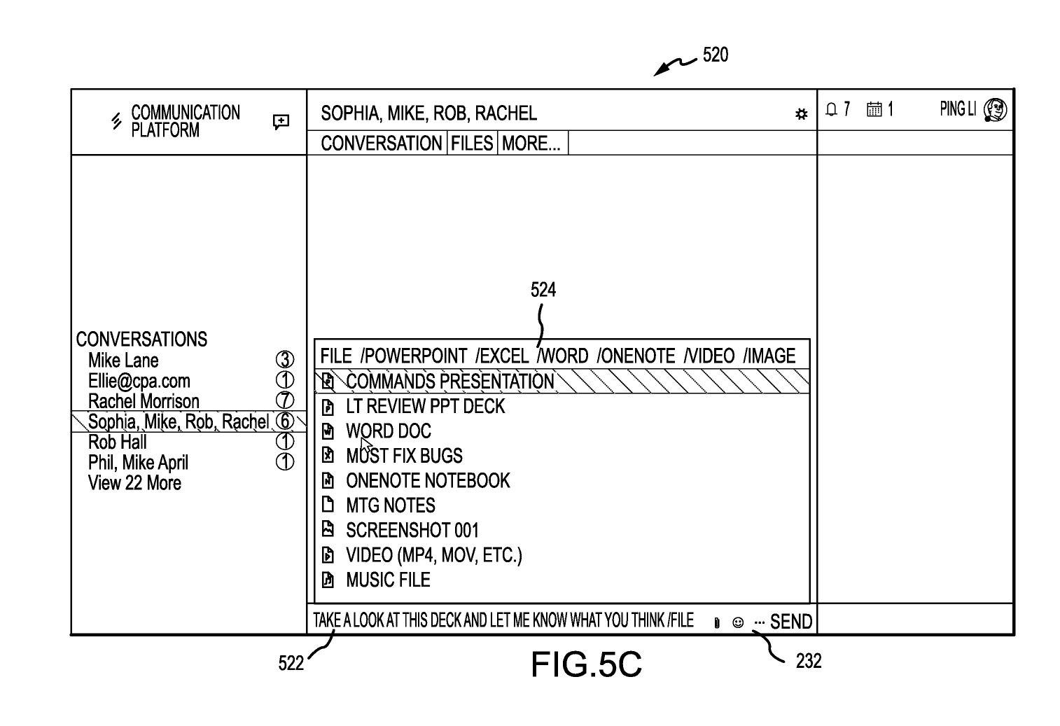

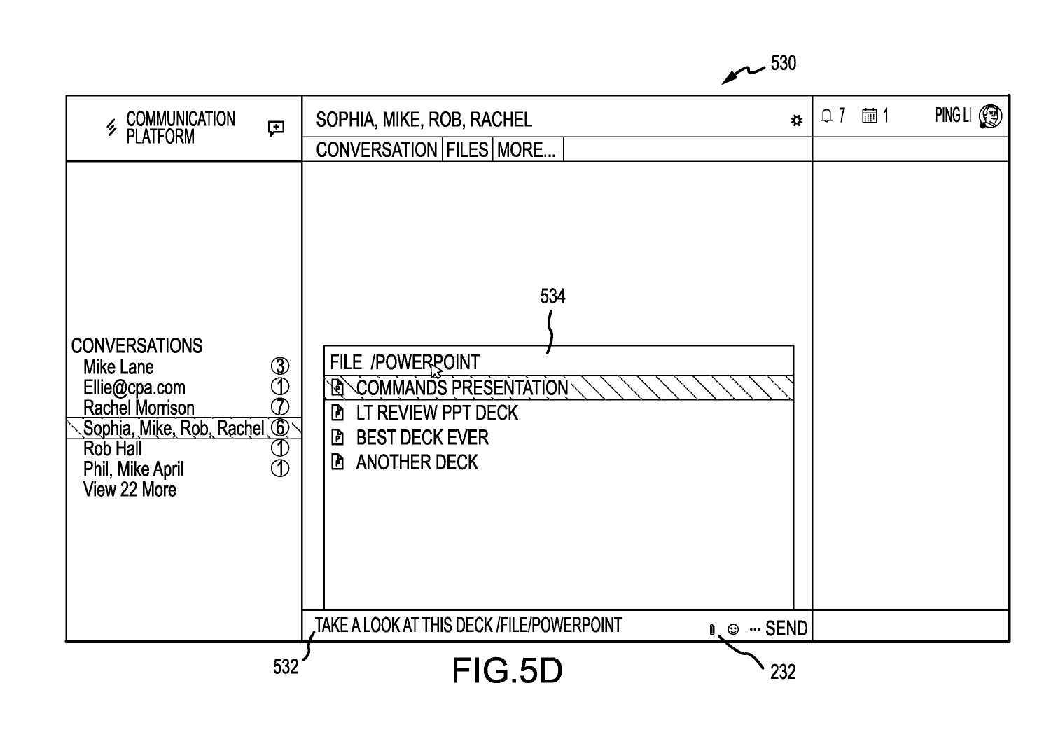

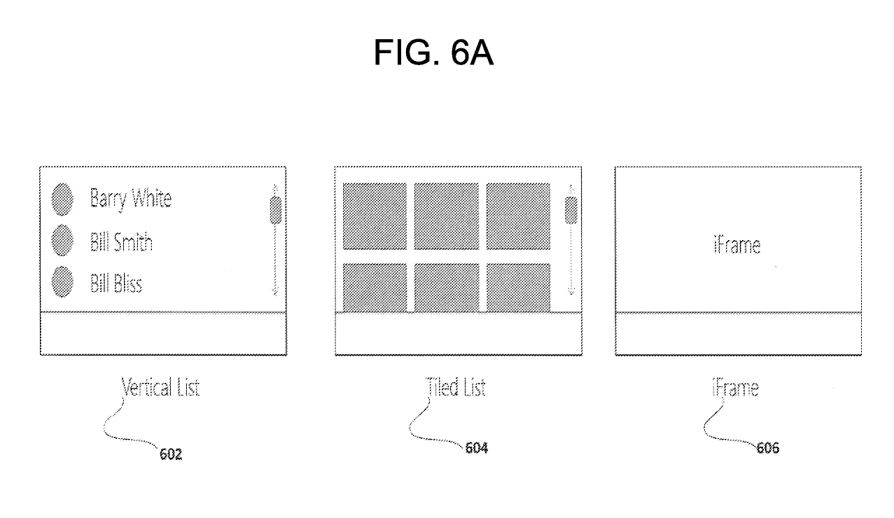

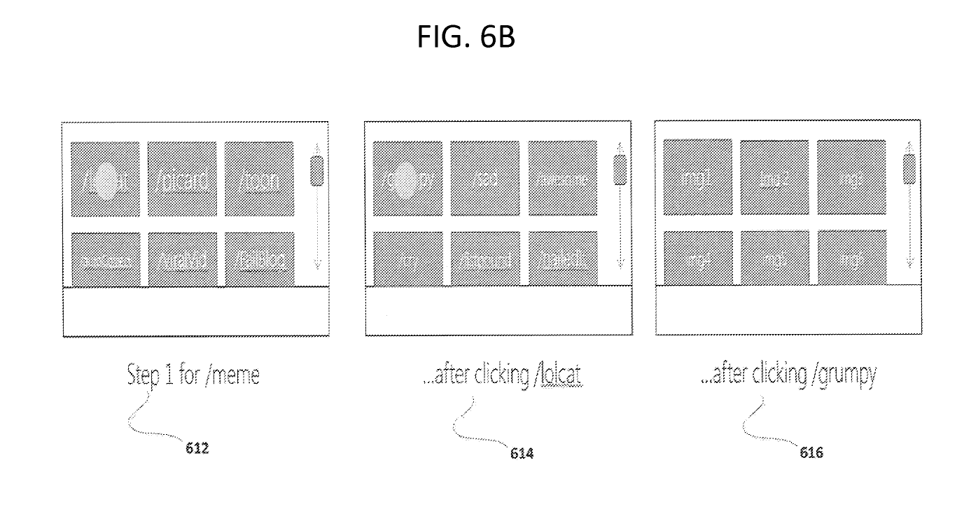

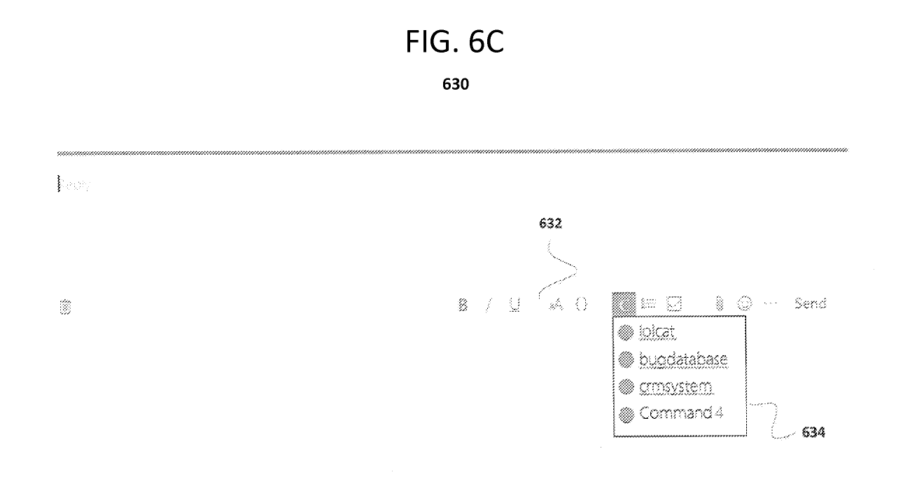

The command line component 310 is a component of the command processing components 306 that interfaces with the user interface 308 and the command handler component 312 to enable command processing in a collaborative communication system/service. In one example, the command processing component 310 is implemented upon the middle tier 106b of the server computing device 106 and communicates with the front end 106a and backend 106c of the server computing device 106 to facilitate command processing. However, one skilled in the art will recognize that any processing device can be configured to perform specific operations of the command processing component 310. The command processing component 310 may exchange commands and information with the user interface component 308 may also exchange the commands and information with one or more components of the server computing device 106. In one example, the user interface component 308 may present an input entry field such as the input entry field 232 shown in at least FIG. 2B. The command line component 310 may communicate with the user interface component 308 to provide command options within the collaborative communication system/service, for example as shown and described with respect to FIGS. 5A to 6C. Furthermore, the command line component 310 may perform operations described in at least method 400 (FIG. 4A), method 440 (FIG. 4C) and method 460 (FIG. 4D), among other examples. In examples of system 300, the command line component 310 may communicate with at least one storage 314 to store data for enabling command line processing within the collaborative communication system/service.

The command handler component 312 is a component of the command processing components 306 that interfaces with the user interface 308 and the command line component 310 to enable command processing in a collaborative communication system/service. In one example, the command handler component 312 is implemented upon the middle tier 106b of the server computing device 106 and communicates with the front end 106a and backend 106c of the server computing device 106 to facilitate command processing. However, one skilled in the art will recognize that any processing device can be configured to perform specific operations of the command handler component 312. The command handler component 312 may communicate with the user interface component 308 and the command line component 310 to provide registration and implementation of command options/command line processing within the collaborative communication system/service, for example as shown and described with respect to FIGS. 5A to 6C. Furthermore, the command handler component 312 may perform operations described in at least method 400 (FIG. 4A), method 440 (FIG. 4C) and method 460 (FIG. 4D), among other examples. In one example, the command handler component 312 interfaces with external resources (e.g., external resources 114 of FIG. 1) to enable external resources to register command handlers with a collaborative communication system/service. In other examples, the command handler component 312 may interface with first-party resources to enable processing of command handlers. First-party resources are resources that are included within the unified communication platform. For instance, the command handler component 312 may be configured to be able to process command handlers for processing operations that are specific to the unified command platform. In examples of system 300, the command handler component 312 may communicate with at least one storage 314 to store registration data related to a command handler so that the collaborative communication system/service can interact with external resource to enable command processing in the collaborative communication system/service. Registration data associated with commands/command handlers is described in the description of method 400 (FIG. 4A). As one example, the command handler component 312 may interface with third-party services to enable third party services to register command handlers with the collaborative communication system/service. Examples of interaction between a third-party service and the collaborative communication system/service are described in method 420 (FIG. 4B). In addition to registration data being registerable for command processing by external resources, an exemplary unified communication platform is configurable to manage registration data for first-party resources as well as second-party resources.

FIG. 4A illustrates an exemplary method for interaction between the unified communication platform and an external resource, according to examples described herein. As an example, method 400 may be executed by an exemplary system as shown in FIGS. 1 and 3. In examples, method 400 may be executed on a device comprising at least one processor configured to store and execute operations, programs or instructions. However, method 400 is not limited to such examples. In at least one example, method 400 may be executed (e.g., computer-implemented operations) by one or more components of a processing device or components of a distributed network, for instance, web service/distributed network service (e.g. cloud service). System components may be utilized to perform the operations described herein with respect to method 400. As an example, method 400 may be performed by an exemplary collaborative communication system/service. A collaborative communication system/service is an example of the unified communication platform 105 detailed in the description of FIG. 1.

Method 400 begins at operation 402 where a collaborative communication system/service interfaces with an external resource. As identified above external resources (e.g., external resources 114) are any resource (e.g., system, application/service, etc.) that exists and is manageable outside of the unified communication platform 105. External resources include but are not limited to systems, application/services that may be managed by a same organization as the unified communication platform 105 (e.g., other services provided by an organization such as web search services, e-mail applications, calendars, device management services, address book services, informational services, etc.) as well as services and/or websites that are hosted or controlled by third parties. In examples, the collaborative communication system/service may send/receive requests to enable interaction between the collaborative communication system/service and external resources. For instance, handshake operations may establish one or more communication channels between the collaborative communication system/service and an external resource. Handshake operations dynamically set parameters of a communications channel established between collaborative communication system/service and an external resource before normal communication over the channel begins. As an example, application agents (e.g., application agents 106d) may interface with external resources 114 using webhooks in order to facilitate integration between a unified communication platform and external resources. In other examples, application programming interfaces (APIs) may enable interaction between a collaborative communication system/service and external resources.

The collaborative communication system/service may be customizable and configurable to control interaction with an external resource/service. As an example, registration between the collaborative communication system/service and an external resource/service may be a single operation that occurs one time. The collaborative communication system/service may also be customizable and configurable to control interaction between a client and external resources/services. In some examples, once an external resource has registered with the collaborative communication system/service, the collaborative communication system/service may enable a client (e.g., client unified communication application 104a) to communicate directly with a registered external resource/service 114. That is, the collaborative communication system/service may be used to broker a connection between a client and an external resource.

Flow proceeds to operation 404 where registration data for a command handler is received from an external resource. As described in an example above, application agents (e.g., application agents 106d) may interface with external resources 114 using webhooks in order to facilitate integration between a collaborative communication system/service (e.g., a unified communication platform) and external resources. In other examples, APIs may enable interaction between a collaborative communication system/service and external resources to enable transmission of registration data. In one example, collaborative communication system/service enables a third-party service to register command handlers that may be utilized by the collaborative communication system/service. For example, a third-party service may provide a capability or functionality that may be included within the collaborative communication system/service to improve a user experience. Registration data is any data associated with a command/command handler that may be useful in communication between the collaborative communication system/service and an external resource for command line processing involving the command/command handler. As an example, registration data may comprise parameters that define a command/command handler. In examples, external resources may define parameters associated with a command/command handler. However, in other examples, the collaborative communication system/service may receive data from an external resource and generate registration data for managing a command/command handler. As identified above, registration data may also relate to command handlers for first-party resources controlled by the collaborative communication system/service. Portions of a command handler that may be defined for any commands within the collaborative communication system/service may comprise but are not limited to:
Trigger methods: 1^{st} and 3^{rd} parties
Trigger scope: indicator/first character/inline
Interaction mode: vertical list; tiled list, iFrame
Parameter format: options enum; optional or required string; command text
Launch UI: no UI; can be included in toolbar; message; search etc.
   One skilled in the art will recognize that format of registration data for command handler is not limited to format and content of the example provided above. Registration data may comprise any data that is usable by a collaborative communication system/service to manage command handler registration and processing. The exemplary data listed above, among other portions of registration data, may be provided to or requested by the collaborative communication system/service. Trigger method data may correspond to identification of parties that interact with the collaborative communication system/service in response to triggering of a command handler and how such parties interact with the collaborative communication system/service. Trigger method data may vary depending on the command handler being registered. As shown in the example above, triggering methods may be associated with first-party resources and third-party resources, among other examples. Trigger scope data relates to interaction within the collaborative communication system/service that may trigger command processing. Trigger scope data may vary depending on the command handler being registered. As shown in the example above, command processing may be triggered (e.g., trigger scope) based on an indicator, a first character input or inline within operations of the collaborative communication system/service, among other examples. Interaction mode data relates to how result data generated from command line processing displays within the collaborative communication system/service. Interaction mode data may vary depending on the command handler being registered. In examples, result data may be displayed in forms such as a vertical list, a tiled list, and iFrame, among other examples. See FIGS. 6A-6C illustration examples of vertical list, tile list and iFrame representations. Parameter format data is data describing how command parameter data can be specified in the collaborative communication system/service. Parameter format data may vary depending on the command handler being registered. As shown in the example above, parameter format data for a command handler may be an enumerated type, string, text, etc. In examples, parameter format data may be further specified as being optional or required. Launch UI data is any specifying how a command handler can interact within a user interface of a collaborative communication system/service. For instance, launch UI data may specify whether a UI element is created for a command handler, whether the command handler is to be included in a UI toolbar, and where and how command handler registration data appears within the collaborative communication system/service (e.g., message input field, search field, etc.). In one example, a UI element may be a UI widget that is incorporated within the collaborative communication system/service. For instance, command processing may be launched within the collaborative communication system/service through the UI widget. Launch UI data may vary depending on the command handler being registered.

Further, another example of registration data may comprise exemplary parameter fields similar to (but not limited to):
Trigger method: slash
Trigger scope: firstChar∥inline
   Interaction: Choice
      filterParameters:
         TopLevelCategory
         2ndLevelCategory
SearchParameter: CustomCaption
Can be in toolbar: yes.
   One skilled in the art will recognize that format of parameters of registration data is not limited to format and content of the example provided above. As an example, trigger method data may be input (e.g., slash, click-action, voice, etc.) that acts as a trigger for calling a command within an exemplary collaborative communication system/service. Trigger method data may vary depending on the command handler being registered. Trigger scope data is described above in the previous example and may vary by command handler. Interaction data is data indicating an interaction with a user of a collaborative communication system/service such as how result data is presented to the user (e.g., choice). Interaction data may vary depending on the command handler being registered. Filter parameter data is data that further specifies how result data is to be searched, returned and/or presented to a user of the collaborative communication system/service. For instance, the collaborative communication system/service enables a user to enter input via UI elements (e.g., as shown and described in FIGS. 6A-6C), where parameters may be arranged and shown to a user and a user selection of a UI element results passing of a parameter for command processing. Filter parameter data may vary depending on the command handler being registered. Search parameter data is data indicating how command parameters can be searched. Search parameter data may vary depending on the command handler being registered. As examples, parameters can be searchable using search terms, custom input (e.g., CustomCaption), and structured UI elements (e.g., lists, arranged data, images, etc.), among other examples. Further, registration data may include a plurality of custom fields that enable customization of parameters. As identified above, parameters for registration data may be defined by one or more of the collaborative communication system/service and external resources. For instance, a feature in the example above may indicate whether the command may be included in a UI toolbar within the collaborative communication system/service.

Flow proceeds to operation 406 where registration data is stored in a storage of the collaborative communication system/service. The collaborative communication system/service may maintain registration data to enable command handlers to be exposed/displayed through the UI of the collaborative communication system/service. Users of the collaborative communication system/service may utilize such command handlers during use of the collaborative communication system/service. In one example a storage is storage 314 described in system 300. Storage is any technology consisting of computer components and recording media used to retain digital data. Examples of storage comprise but are not limited to memory, memory cells, data stores, and virtual memory, among other examples.

Flow may proceed to decision operation 408 where the collaborative communication system/service determined whether input is received through a UI of the collaborative communication system/service that may trigger display of the command handler. A trigger is an input received through the UI of the collaborative communication system/service and may comprise but is not limited to: an entered character, number, symbol, word, and selected UI item, among other examples. An exemplary format for entry of command input may be similar to (but not limited to): Command Format: /commandName/filterParam1/filterParam2 “stringParam.” However, command input may not include all parameters described in the exemplary command input format. Each command input may have zero or more filter parameters. In one example, filter parameters are always applied in order. In examples, each command input may be recognized as a string parameter including one or more characters. If no input is received that triggers display of the command handler, flow branches NO and processing of method 400 ends. However, if it detected that input has been entered that may trigger display of the command handler, flow branches YES and proceeds to operation 410. In examples, operation 408 may occur multiple times as user input is received by the collaborative communication system/service. For instance, an initial input may be entered and processed by the collaborative communication system/service, and further input may be received that modifies a received input. Operation 408 may occur anytime an input is received that comprises a command trigger or any other input that the collaborative communication system/service interprets as an intention of command processing.

In operation 410, the collaborative communication system/service presents the stored command handler in the UI to enable utilization/command line processing involving the stored command handler. As an example, the collaborative communication system/service may communicate with one or more storages of the collaborative communication system/service as well as an external resource (and system associated with such external resource) to enable processing and display of a command handler within the collaborative communication system/service. In one example, presenting of a command handler may comprise displaying a command handler. In another example, presenting of a command handler may comprise displaying a listing or grouping of commands that can be called/executed, for example, as shown in FIGS. 5A and 5C. In examples, command handlers may be associated with actions to occur within the collaborative communication system/service and display of files/links/URLs, among other examples.

In examples, method 400 may comprise decision operation 412 where it is determined whether update to the registration data is received. As an example, update to the registration data may be received from an external resource such as a third-party service. If no update to the registration data is received, flow branches NO and processing of method 400 ends. However, if an update to the registration data is received, flow branches YES and flow returns to operation 406 where the stored registration data is updated. In such examples, the updated registration data stored by the collaborative communication system/service may be utilized upon detection of input that may trigger use of commands associated with stored command handlers. In some examples, update to registration data may occur dynamically. In other examples, registration and update of registration data may be managed by administrators of the collaborative communication system/service. In one example, metadata associated with registrations data may be tied to an extension which is packaged as an add-in to be managed by administrators of the collaborative communication system/service. In response to a change in parameters of registration data, the add-in may be updated and handled by a predetermined update cycle to update one or more pieces of registration data. As a note, programming code and user interface elements associated with registered parameter data are likely to be updated when registration data is changed/updated. As such, the collaborative communication system/service may manage registration data and updates to the registration data appropriately to update the collaborative communication system/service in the best manner possible.

FIG. 4B illustrates an exemplary method 420 executed by a third-party service, according to examples described herein. As an example, method 420 may be executed in accordance with exemplary systems as shown in FIGS. 1 and 3. In examples, method 400 may be executed on a device comprising at least one processor configured to store and execute operations, programs or instructions. However, method 420 is not limited to such examples. In at least one example, method 420 may be executed (e.g., computer-implemented operations) by one or more components of a processing device or components of a distributed network, for instance, web service/distributed network service (e.g. cloud service). System components may be utilized to perform the operations described herein with respect to method 420. As an example, method 400 may be performed by an external resource (e.g., external resource 114 of FIG. 1) such as a third-party service.

Flow of method 420 begins at operation 422 where the third-party service registers with a collaborative communication system/service. As described in an example above, application agents (e.g., application agents 106d) may interface with external resources 114 such as third-party services using webhooks in order to facilitate integration between a unified communication platform and third-party services. In other examples, APIs may enable interaction between a collaborative communication system/service and third-party services to enable transmission of registration data. Examples of registration data are provided above in the description of method 400 (FIG. 4A).

Flow proceeds to operation 424 where parameters are generated that define a command associated with a command handler. Examples of parameters that may be used to define a command/command handler are described above with respect to the description of method 400 of FIG. 4A.

Flow then proceeds to operation 426 where the third-party service registers the command handler with the collaborative communication system/service. In examples, a third party service may interface with the collaborative communication system service, through webhooks, APIs, and any other type of requests/responses such as (HTTP requests, JSON requests, etc.).

In decision operation 428, the third-party service may determine whether registration data for the command handler is to be updated. For example, the third-party service may update the parameters associated with a command/command handler. If the registration data (e.g., comprising parameters of for the command/command handler) is to be updated, flow branches YES and proceeds to operation 430 where the updated registration data is transmitted to the collaborative communication system/service. Flow then returns to operation 426 where the third-party service may interact with the collaborative communication system/service to confirm that the command handler is registered with collaborative communication system/service.

If the registration data (e.g., comprising parameters of for the command/command handler) is not updated, flow branches NO and processing of method 420 proceeds to decision operation 432. In decision operation 432, the third-party service determines whether a request associated with the command handler is received. As an example, the collaborative communication system/service may send a request that includes parameters indicating that the command handler is called in the collaborative communication system/service. If a request is not received from the collaborative communication system/service, flow branches NO and processing of method 420 ends. If a request is received from the collaborative communication system/service, flow branches YES and proceeds to operation 434 where the third-party service interacts with the collaborative communication system/service to execute processing associated with the command/command handler.

FIG. 4C illustrates an exemplary method 440 for processing performed by the unified communication platform, according to examples described herein. As an example, method 440 may be executed by an exemplary system as shown in FIGS. 1 and 3. In examples, method 440 may be executed on a device comprising at least one processor configured to store and execute operations, programs or instructions. However, method 440 is not limited to such examples. In at least one example, method 440 may be executed (e.g., computer-implemented operations) by one or more components of a processing device or components of a distributed network, for instance, web service/distributed network service (e.g. cloud service). System components may be utilized to perform the operations described herein with respect to method 400. As an example, method 440 may be performed by an exemplary collaborative communication system/service. A collaborative communication system/service is an example of the unified communication platform 105 detailed in the description of FIG. 1.

Flow of method 440 begins at operation 442 where a command input is received through a UI of a collaborative communication system/service. Input is any data (including indications of user action) received through the UI of the collaborative communication system/service. Input may be in any form and received by any of a plurality of input methods including but not limited to: keyboard entry (e.g., physical keyword or soft input panel (SIP), audio data, video data, touch/click actions (e.g., mouse clicks/touchscreens), and transmitted signals, etc. Command input is any input that is entered into input entry field 232 (described in description of FIG. 2) that may be associated with a command/command handler. Commands are custom triggers in messages across all aspects of the collaborative communication system/service and external resources. When a command is triggered, relevant data will be sent/retrieved in real-time. Data may be selected in the UI of the collaborative communication system/service that triggers exposure to commands that may be utilized by the collaborative communication system/service. An exemplary collaborative communication system/service is configured to process a plurality of inputs (e.g., N inputs). That is, each time (e.g., N number of times) a user enters a command input operation 442 is executed to process the command input. A commanding framework of the collaborative communication system/service works with a plurality of different scenarios including but not limited to: message content insertion (e.g., insert data including images, names, items, tasks, files, locations, videos, sounds, authoring efficiency (e.g., add emoji, message specifics, reference important information (@mentions), semantic content insertion (e.g., approve plan, file to share), quick actions to control/query (collaborative communication system/service management, reminders, invitations, presence, etc.), request information from resources such as first-party resources, second party-resources, and third-party resources.

Receipt of a command input may be detected (operation 442) based on identification of a trigger. As identified above, a trigger is an input received through the UI of the collaborative communication system/service and may comprise but is not limited to: an entered character, number, symbol, word, and selected UI item, among other examples. An exemplary format for entry of command input may be similar to (but not limited to): Command Format: /commandName/filterParam1/filterParam2 “stringParam.” However, command input may not include all parameters described in the exemplary command input format. Each command input may have zero or more filter parameters. In one example, filter parameters may be applied in order. In examples, each command input may be recognized as a string parameter including one or more characters.

Flow proceeds to operation 444 where a first query is processed by the collaborative communication system/service. As an example, operation 444 may comprise generating a query and passing the query to a command resource for further processing. In one example, operation 444 may comprise transmitting a first query to a command resource. A command resource is a first-party resource, a second-party resource or a third-party resource that executes a command. In one example, a command resource may be an external resource as described previously. Continuing that example, processing (operation 444) of the first query may generate a query and transmit the query to an external resource upon identification/detection (operation 442) of receipt of the command input. In another example, operation 444 may comprise processing the command input using resources within the collaborative communication system/service. For instance, operation 444 may determine that a command input is to be processed by a first-party resource or resource embedded within the collaborative communication system/service. In that example, a generated query would be processed within the collaborative communication system/service.

In one example, the command input may be received during authoring in the collaborative communication system/service. For instance, a user may be generating a communication (e.g., email, message, message thread, etc.) as shown in FIGS. 2A-2E. As an example, multiple users may communicating in a message thread where one user may be responding to the thread with an input such as “Matthew, it was great to see you and/assistant kidsnames.” In such an input, a user may be requesting a personal assistant application to find and insert the names of Matthews' kids into the input field before sending a communication into the thread that includes a user named Matthew. In that example, the “/assistant” in the input may act as a trigger to call a personal assistant application to locate and return data associated with user's request. The collaborative communication system/service may receive such an input and send a first query to an external resource (e.g., the personal assistant application) that may comprise parameters of the command input and a context associated with the authoring. Context associated with the authoring may comprise any information that is available regarding states of operation of the collaborative communication system/service. In examples, context may comprise but is not limited to: text entered in the input entry field 232, current/previous communications (e.g., messages, emails, threads, etc.), where the command input is entered, who is involved in the authoring/communication, who is involved in a team/group of the collaborative communication system/service, content associated with communication/authoring, content included in communications, information of users of the collaborative communication system/service, timestamp information, sensitivity (e.g., time, and/or privacy) and features associated with the collaborative communication system/service, among other examples. In the example described above where the input is directed to the personal assistant application identifying the names of Matthews' children, context may user profile information associated with a user, Matthew, and information usable by the personal assistant application to identify the names of Mathews' children. For instance, the collaborative communication system/service may provide context information with respect to who the user named Matthew is so that the personal assistant application can most efficiently and accurately satisfy a user command request. As noted above, context passed to any resources resource complies with a standard upholding privacy protection for users of the collaborative communication system/service. For instance, a stored contact entry for a user named Matthew may have associated information that includes the names of his children. The personal assistant application may return such information or may seek out such information that is available to satisfy an input request. In some examples, a back and forth interaction (e.g. a plurality of back and forth communications/handshakes) may occur between a command resource and the collaborative communication system/service. For instance, a personal assistant may request clarification related to the command input and/or context provided. Clarification of context is described in greater detail in the description of method 460 (FIG. 4D). In some examples, the collaborative communication system/service may request clarification from the user with regard to a received input.

Flow may proceed to operation 446 where a response is generated to the received command input. In examples, a first response is generated by the command resource. In one example, a command resource may be an external resource. In that example, the external resource may receive a query and generate a response based on parameters associated with the command input received from the collaborative communication system/service and the context provided by the collaborative communication system/service. However, in alternative examples, context may not need to be provided by the collaborative communication system/service to enable command processing. In any example, a generated first response (operation 446) may comprise result data and parameters for interacting with the collaborative communication system/service. In some examples, a back and forth interaction (e.g. a plurality of back and forth communications/handshakes) may occur between a command resource and the collaborative communication system/service to generate a response to a received command input. Examples of parameters for interacting with the collaborative communication system/service may comprise ways to display and/or browse result data provided as well as checking whether further interaction is to occur such as whether an update to the command input has been received by the collaborative communication system/service. For instance, building off the example above where input is related to identification of children names of a user named Matthew, result data may include the names of Matthews' children names or a listing of potential options of names that a user may select from.

Flow proceeds to operation 448 where results data is presented in the UI of the collaborative communication system/service. In one example, presenting of the result data may comprise inserting the result data into a communication being authoring the UI of the collaborative communication system/service. For instance, building off the example above where input is related to identification of children names of a user named Matthew, if the personal assistant operation is confident with respect to the names to insert, such information may be inserted into the message for the user to include in the threaded message with Matthew. In one example result data is presented inline in a communication being authored. In another example, presenting of the result data may comprise displaying result data to be browsed and/or selected by a user of the collaborative communication system/service. As an example, result data may be inserted into a communication upon selection by a user of the collaborative communication system/service. That is the collaborative communication system/service may interface with a command resource to enable auto completion of a user command request, for example, allowing the user to pick the documents/data/files to incorporate (e.g., select from results data provided by a command resource) and then continue authoring a message.

Flow may proceed to decision operation 450 where it is determined whether update to the command input is received. If not, flow branches NO and processing of method 440. In examples, the collaborative communication system/service may enable a user to update a command input in real time. That is, a command input can change and the collaborative communication system/service may communicate with command resources (e.g., external resources) in real-time to correspond with an updated input. For instance, continuing the example above with respect to an input having a command for the personal assistant application, an input may be updated to “Matthew, it was great to see you and/assistant kidsnames and wifename.” The collaborative communication system/service is configured to interface with command resources to update result data in real-time.

If an update to the command input is received, flow branches YES and proceeds to operation 452 where a subsequent query is transmitted to the command resource. The subsequent query (e.g., second query) that is transmitted (operation 452) comprises parameters of the updated command input/and or context for the updated command input. In some examples, a back and forth interaction (e.g. a plurality of back and forth communications/handshakes) may occur between a command resource and the collaborative communication system/service to process the subsequent query and ultimately generate an updated response.

Flow proceeds to operation 454 where a response to the subsequent query is received from the command resource. In examples, a plurality of subsequent queries may be received and processed by the collaborative communication system/service. As one example, the response to the subsequent query may comprise updated results data based on the updated command input and/or the context, which may have been provided in a previous query. In the example described above where an input was updated requesting entry of the name of Matthews' wife, the collaborative communication system/service may interactive with a command resource (e.g., embedded resource and/or external resource) to identify and return data to satisfy the updated command input.

Flow proceeds to operation 456 where the updated result data is presented in the UI of the collaborative communication system/service. In one example, presenting of the updated result data may comprise inserting the updated result data into a communication being authoring the UI of the collaborative communication system/service. In one example updated result data is presented inline in a communication being authored. In another example, presenting of the result data may comprise displaying updated result data to be browsed and/or selected by a user of the collaborative communication system/service. As an example, updated result data may be inserted into a communication upon selection by a user of the collaborative communication system/service. In examples, updated result data may be inserted into an authoring replacing a previously inserted item/object or alternatively, being presented along with a previously inserted item/object. Flow may return back to operation 442 when additional command input is received.

FIG. 4D illustrates an exemplary method for evaluating communications between a unified communication platform and a command resource, according to examples described herein. As previously described, a command resource is a first-party resource, a second-party resource or a third-party resource that executes a command. In one example, a command resource may be an external resource as described previously. As an example, method 460 may be executed by an exemplary system as shown in FIGS. 1 and 3. In examples, method 460 may be executed on a device comprising at least one processor configured to store and execute operations, programs or instructions. However, method 460 is not limited to such examples. In at least one example, method 460 may be executed (e.g., computer-implemented operations) by one or more components of a processing device or components of a distributed network, for instance, web service/distributed network service (e.g. cloud service). System components may be utilized to perform the operations described herein with respect to method 460. As an example, method 460 may be performed by an exemplary collaborative communication system/service. A collaborative communication system/service is an example of the unified communication platform 105 detailed in the description of FIG. 1.

Method 460 begins at decision operation 462 where it is determined whether a communication error occurred during interaction with a command resource. If a communication error is identified, flow branches YES and proceeds to operation 464 where a communication is re-initiated with a command resource. In one example, a request may be re-sent to the command resource such as the external resource. In examples, operation 464 may comprise multiple communications between the collaborative communication system/service and a command resource to re-initiate communication. Processing flow may end or start again (if another communication error is detected. In alternative examples, network administrators of the collaborative communication system/service may evaluate the communication error to and attempt to resolve the issue to enable communication between the collaborative communication system/service and external resources.

If a communication error is not identified, flow branches NO and proceeds to decision operation 466 where it is determined whether context of an authoring in the collaborative communication system/service was provided to the command resource. If not, flow branches NO and processing of method 460 ends. If context was provided, flow branches YES and proceeds to decision operation 468.

In decision operation 468, it is determined whether the context was understood by the command resource. If context was processed (e.g., a transmission is received with accurate result data) correctly, flow branches YES and processing of method 460 ends. If not, flow branches NO and proceeds to operation 470 where the context is clarified for the command resource. Operation 470 further comprises re-requesting result data from the command resource.

Flow may proceed to operation 472 where updated result data is received. In alternative examples, the collaborative communication system/service may evaluate the accuracy of the updated results data and interaction with the command resource may change depending on such a determination.

Flow may proceed to operation 474 where the updated result data is presented/displayed through the UI of the collaborative communication system/service.

FIG. 5A illustrates an exemplary interface for interacting with the unified communication platform, according to examples described herein. FIG. 5A illustrates an exemplary collaborative communication UI view 502. Collaborative communication UI view 502 illustrates entry of a command input 504 into the input entry field 232. As can be seen in collaborative communication UI view 502, the slash (/) input acts as a trigger for the UI to expose/display a plurality of commands/command handlers 506 that are integrated with the collaborative communication system/service. For instance, when a trigger for a command input 504 is entered into the input entry field 232, the collaborative communication system/service shown in UI view 502 may present an auto-complete list of potential commands to call/execute, as shown in item 506. For instance, a user may be in the process of typing a command input 504 that includes one or more characters of input where the collaborative communication system/service may adapt in real-time to display commands associated with the input. As an example, a command input of “/assist” may be entered and the plurality of command handlers 506 displayed may adjust to display a list of potential command handlers associated with the input, for example, “assistant.” In examples, the plurality of commands/command handlers 506 may update depending on a command input 502 received by the collaborative communication system/service.

In exemplary UI view 502, command input 502 is being entered during authoring of a conversation (e.g., communication between users/team members of the collaborative communication system/service). Item 212 of UI view 502 illustrates that the command input 504 is being entered within a conversation between a plurality of users (e.g., Sophia, Mike, Rob, Rachel). As can be seen in UI view 502, a left rail of the UI shows a listing of conversations that may be on-going. A user may use such a feature to conveniently switch between conversations/communications. Command input 504 may be entered into any of the conversations (e.g., communication threads, emails, etc.). However, one skilled in the art will recognize that command input 504 is not limited to conversation threads of the collaborative communication system/service. Command input 504 may be associated with any feature of the collaborative communication system/service including but not limited to communications/conversations, search functionality, files, text input, and links/URLs, semantic objects, etc. An example of a semantic object is illustrated in FIG. 2E, is a real-time object where data/content may can be incorporated/updated in real-time rather than adding a plurality of communication responses/inputs into a lengthy thread. For instance, an example of a semantic object may be a workstream shown in FIG. 2E where data (e.g., naming conventions, owners, statuses, message content/conversations, etc.) can be updated in real-time.

FIG. 5B illustrates an exemplary interface for interacting with the unified communication platform, according to examples described herein. FIG. 5B illustrates an exemplary collaborative communication UI view 510. Collaborative communication UI view 510 illustrates entry of an updated command input 512 into the input entry field 232. As can be seen in collaborative communication UI view 510, the updated command input entry 512 changes the commands/result data 514 displayed in the UI of the collaborative communication system/service. Furthermore, the collaborative communication system/service may provide auto-completed command input options for the user to complete a command input 512. For instance, a user may enter a command searching for an animated image and may specify command parameters that refine an input search. The collaborative communication system/service may interface with a command resource (e.g., third-party service for animated images) and utilize the command parameters to refine result data provided back to the collaborative communication system/service. As shown in item 514, auto-completion options for command input 512 is provided for a user to more easily select from result data that would satisfy an intention of the user.

FIG. 5C illustrates an exemplary interface for interacting with the unified communication platform, according to examples described herein. FIG. 5C illustrates an exemplary collaborative communication UI view 520. Collaborative communication UI view 520 illustrates entry of an updated command input 522 into the input entry field 232. As can be seen in collaborative communication UI view 520, the updated command input entry changes the commands/result data 524 displayed in the UI of the collaborative communication system/service. For instance, a command of “/file” display file/content commands. As an example, a command interaction that results in the selection of a file, may lead to the file being incorporated into an ongoing communication/conversation.

FIG. 5D illustrates an exemplary interface for interacting with the unified communication platform, according to examples described herein. FIG. 5D illustrates an exemplary collaborative communication UI view 530. Collaborative communication UI view 530 illustrates entry of an updated command input 532 into the input entry field 232. As can be seen in collaborative communication UI view 530, the updated command input entry changes the commands/result data 534 displayed in the UI of the collaborative communication system/service. For instance, specification of a specific file in association with a command handler changes the file list displayed in item 534. In UI view 520 of FIG. 5C, a list of command handlers 524 shows a plurality of types of files that may be selected from. In UI view 530 of FIG. 5D, a listing of command handlers 534 is updated as the command input 532 is changed to specify that a file being search for is a presentation file such as a POWERPOINT file.

FIG. 6A illustrates an exemplary views for displaying content in the unified communication platform, according to examples described herein. As shown in FIG. 6A, content in the collaborative communication system/service UI may be displayed in a vertical list view 602, a tiled list view 604 and an iFrame view 606. Exemplary collaborative communication system/services may be programmed to display content in accordance with one of exemplary views 602-606. Registration data including command parameters associated with a registered command handler may be used to determine how content is displayed in a UI of the collaborative communication system/service. However, one skilled in the art will recognize that displayed content is not limited to exemplary views 602-606. Content may be displayed in any form that may be useful or pleasing to users of the UI. In examples, exemplary views 602-606 may be used to display content (e.g., results data) in an authoring of the of the collaborative communication system/service. However, one skilled in the art will recognize that exemplary views 602-606 may be used for display of content in any manner within the UI of the collaborative communication system/service.

FIG. 6B illustrates an exemplary views for displaying content in the unified communication platform, according to examples described herein. As shown in FIG. 6B, display of content in the collaborative communication system/service UI may adapt in real-time based on user selection or changes to the command input. For instance, view 612 illustrates a first state of displayed content. In examples, display of content may change depending on entry of command input/update to command input. In an example, command parameters may be updated by the making selections within a UI of the collaborative communication system/service. That is, a user may make selections within having to type text for command input parameters. View 614 illustrates a second state of displayed content that changes based on user selection. For instance, when a user makes a selection (e.g., mouse click/touchscreen input, etc.) command parameters and result data may be updated in the UI of the collaborative communication system/service. View 616 illustrates a third state of displayed content that changes after an additional user selection.

FIG. 6C illustrates an exemplary user interface component of the unified communication platform, according to examples described herein. User interface components may take any form. In one example, user interface view 630 illustrates display of a UI component 632 being a toolbar. When an item in the UI component 632 is selected command data 634 may be displayed. As in this example, command input may be received via selection of commands in UI components such as UI component 632. In some instances, the registration process for a command may be interpreted by a collaborative communication system/service such that the collaborative communication system/service makes a UI element (e.g., button) available to users. In examples, a UI element may be customizable, for example by administrators and/or users of the collaborative communication system/service. For instance, UI elements/components may be programmed in a collaborative communication system/service enabling quick action to call commands. In one example, a UI element may be a UI widget that is incorporated within the collaborative communication system/service. For instance, command processing may be launched within the collaborative communication system/service through the UI widget. In examples, UI component 632 may be programmed or adapted by developers of the collaborative communication system/service and/or users. A user, through the UI of the collaborative communication system/service (e.g., front end 106a communicating with other server component such as middle tier 106b) may update an arrangement of commands/ UI objects to include in UI component 632. In examples, positioning of UI component 632 may be variable or adjustable according to user preference. However, in other example, positioning of UI component 632 may be fixed by program developers of the collaborative communication system/service.

FIGS. 7-10 and the associated descriptions provide a discussion of a variety of operating environments in which aspects of the disclosure may be practiced. However, the devices and systems illustrated and discussed with respect to FIGS. 7-10 are for purposes of example and illustration and are not limiting of a vast number of computing device configurations that may be utilized for practicing aspects of the disclosure, described herein

FIG. 7 is a block diagram illustrating physical components (e.g., hardware) of a computing device 700 with which aspects of the disclosure may be practiced. The computing device components described below may have computer executable instructions for implementing efficient factual question answering on a server computing device 108, including computer executable instructions for search engine 711 that can be executed to employ the methods disclosed herein. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program modules 706 suitable for running software applications 720 such as one or more components in regards to FIGS. 1 and 3 and, in particular, extractor component 713, ranker component 715, or scorer component 717. The operating system 705, for example, may be suitable for controlling the operation of the computing device 700. Furthermore, embodiments of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 (e.g., search engine 711) may perform processes including, but not limited to, the aspects, as described herein. Other program modules that may be used in accordance with aspects of the present disclosure, and in particular for efficient factual question answering, may include extractor component 713, ranker component 715, and scorer component 717, etc.

Furthermore, examples of the present disclosure may be practiced in an electrical circuit comprising discrete electronic elements, packaged or integrated electronic chips containing logic gates, a circuit utilizing a microprocessor, or on a single chip containing electronic elements or microprocessors. For instance, examples may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples may be practiced within a general purpose computer or in any other circuits or systems.

The computing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716 allowing communications with other computing devices 718. Examples of suitable communication connections 716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

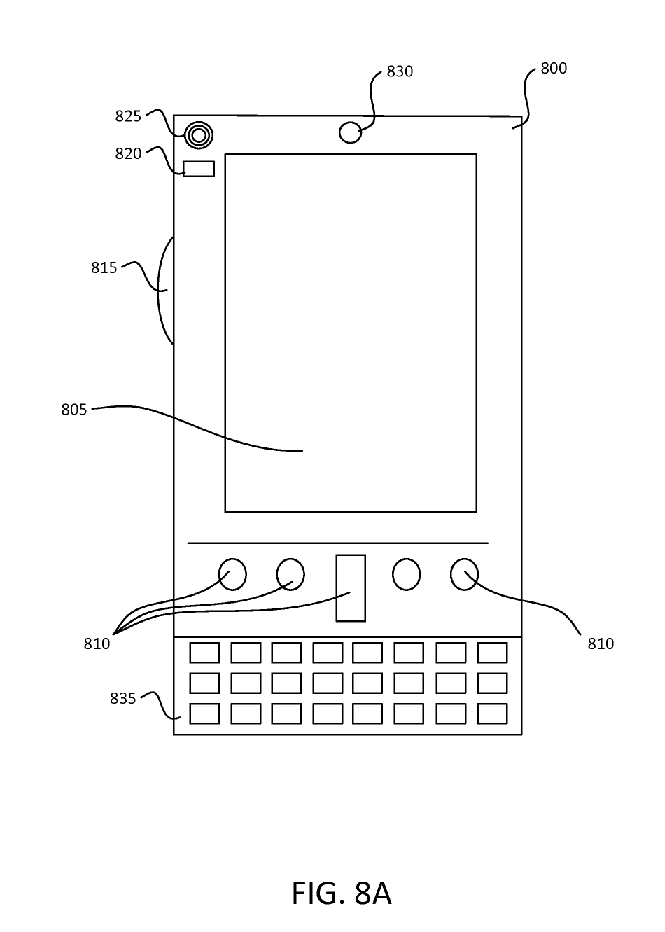

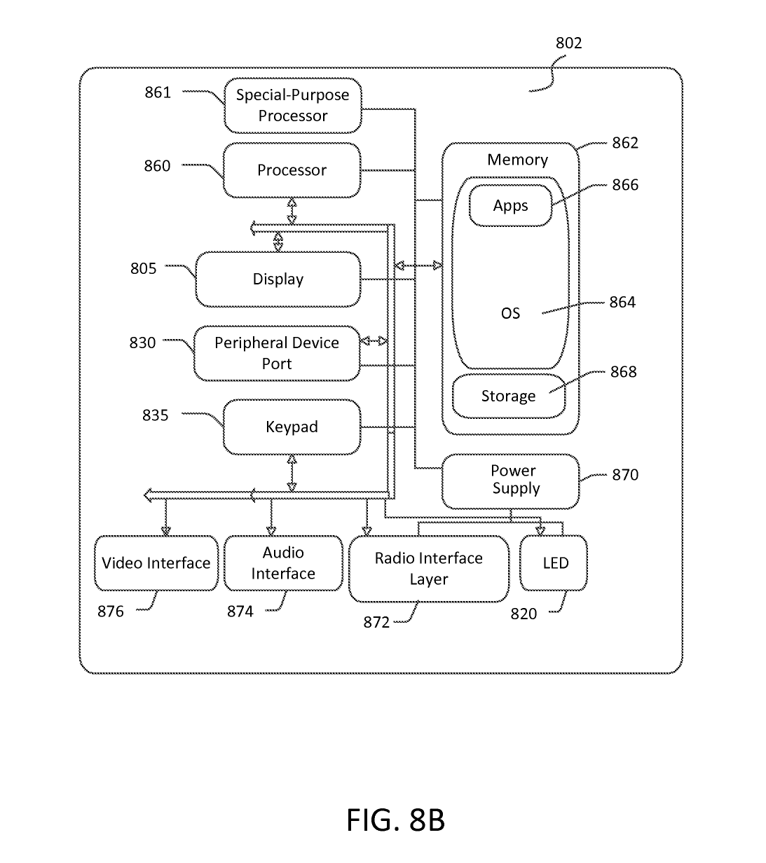

FIGS. 8A and 8B illustrate a mobile computing device 800, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 8A, one aspect of a mobile computing device 800 for implementing the aspects is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. The display 805 of the mobile computing device 800 may also function as an input device (e.g., a touch screen display). If included, an optional side input element 815 allows further user input. The side input element 815 may be a rotary switch, a button, or any other type of manual input element. In alternative aspects, mobile computing device 800 may incorporate more or less input elements. For example, the display 805 may not be a touch screen in some embodiments. In yet another alternative example, the mobile computing device 800 is a portable phone system, such as a cellular phone. The mobile computing device 800 may also include an optional keypad 835. Optional keypad 835 may be a physical keypad or a “soft” keypad generated on the touch screen display. In various embodiments, the output elements include the display 805 for showing a graphical user interface (GUI), a visual indicator 820 (e.g., a light emitting diode), and/or an audio transducer 825 (e.g., a speaker). In some aspects, the mobile computing device 800 incorporates a vibration transducer for providing the user with tactile feedback. In yet another aspect, the mobile computing device 800 incorporates input and/or output ports, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one aspect of a mobile computing device. That is, the mobile computing device 800 can incorporate a system (e.g., an architecture) 802 to implement some aspects. In one embodiment, the system 802 is implemented as a “smart phone” capable of running one or more applications (e.g., browser, e-mail, calendaring, contact managers, messaging clients, games, and media clients/players). In some aspects, the system 802 is integrated as a computing device, such as an integrated personal digital assistant (PDA) and wireless phone.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800, including the instructions for efficient factual question answering as described herein (e.g., search engine, extractor module, relevancy ranking module, answer scoring module, etc.).

The system 802 has a power supply 870, which may be implemented as one or more batteries. The power supply 870 might further include an external power source, such as an AC adapter or a powered docking cradle that supplements or recharges the batteries.

The system 802 may also include a radio interface layer 872 that performs the function of transmitting and receiving radio frequency communications. The radio interface layer 872 facilitates wireless connectivity between the system 802 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 may be used to provide visual notifications, and/or an audio interface 874 may be used for producing audible notifications via the audio transducer 825. In the illustrated example, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with examples of the present disclosure, the microphone may also serve as an audio sensor to facilitate control of notifications, as will be described below. The system 802 may further include a video interface 876 that enables an operation of an on-board camera 830 to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8B by the non-volatile storage area 868.

Data/information generated or captured by the mobile computing device 800 and stored via the system 802 may be stored locally on the mobile computing device 800, as described above, or the data may be stored on any number of storage media that may be accessed by the device via the radio interface layer 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio interface layer 872 or via a distributed computing network. Similarly, such data/information may be readily transferred between computing devices for storage and use according to well-known data/information transfer and storage means, including electronic mail and collaborative data/information sharing systems.

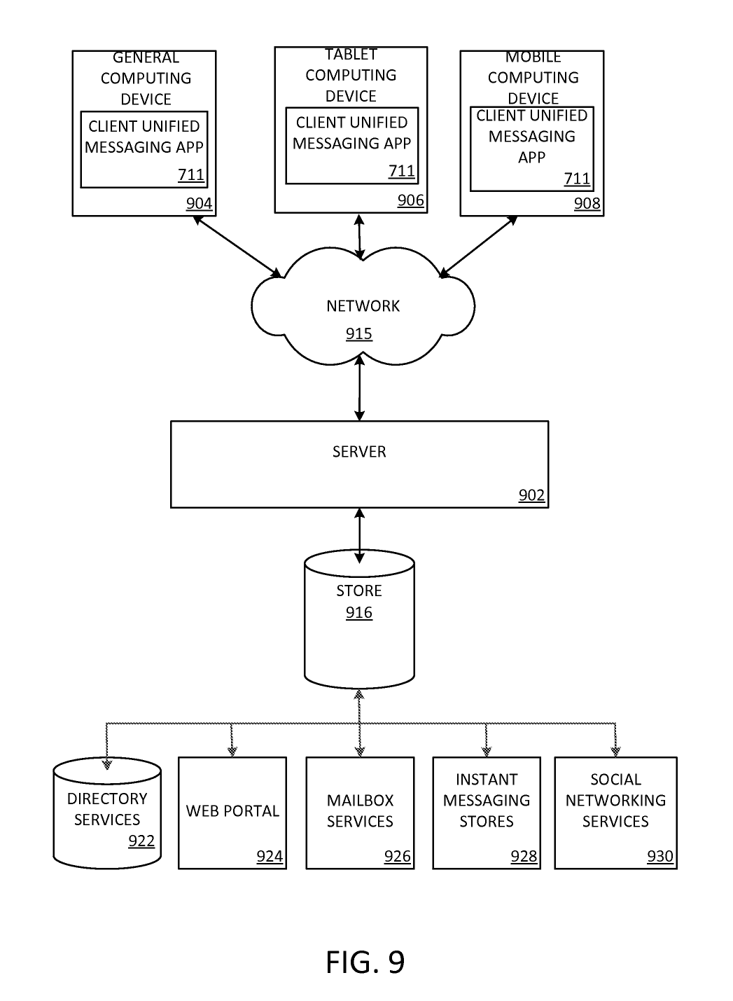

FIG. 9 illustrates one aspect of the architecture of a system for processing data received at a computing system from a remote source, such as a personal computer 904, tablet computing device 906, or mobile computing device 908, as described above. Content displayed at server device 902 may be stored in different communication channels or other storage types. For example, various documents may be stored using a directory service 922, a web portal 924, a mailbox service 926, an instant messaging store 928, or a social networking site 930. The search engine 711 may be employed by a client who communicates with server device 902. The server device 902 may provide data to and from a client computing device such as a personal computer 904, a tablet computing device 906 and/or a mobile computing device 908 (e.g., a smart phone) through a network 915. By way of example, computer system examples described above may be embodied in a personal computer 904, a tablet computing device 906 and/or a mobile computing device 908 (e.g., a smart phone). Any of these embodiments of the computing devices may obtain content from the store 916, in addition to receiving graphical data useable to be either pre-processed at a graphic-originating system, or post-processed at a receiving computing system.

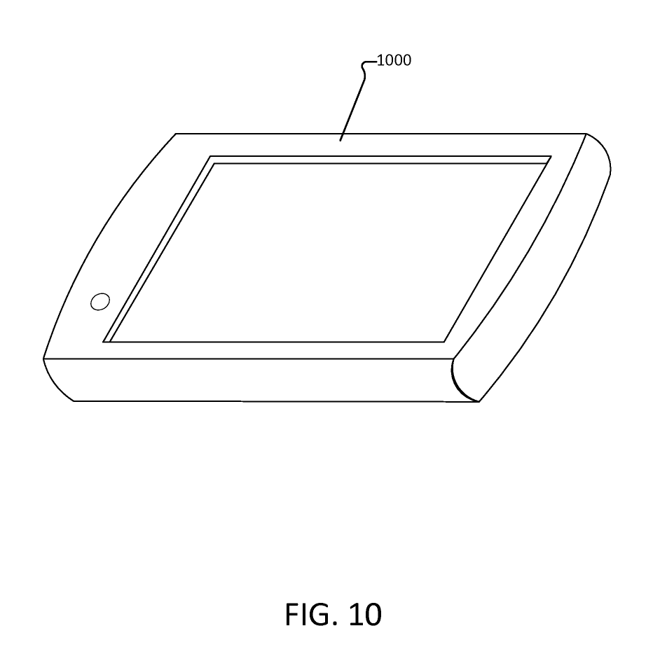

FIG. 10 illustrates an exemplary tablet computing device 1000 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A collaborative communication system comprising:
a memory; and
at least one processor operatively connected with the memory, the processor executing operations that comprise:
in response to command input being received during authoring in a user interface of the collaborative communication system, processing a query based on the received input by passing the query to a command resource, wherein the query comprises parameters of the command input and a context associated with the authoring,
receiving a response from the command resource based on the parameters of the command input and the context, wherein the response comprises result data and parameters for interacting with the collaborative communication system, and
presenting the result data in the user interface.

2. The collaborative communication system according to claim 1, wherein the operations further comprise identifying the command input based on receipt of a trigger from a user.

3. The collaborative communication system according to claim 1, wherein the presenting of the result data further comprises inserting the result data into a communication being authored in the user interface of the collaborative communication system.

4. The collaborative communication system according to claim 1, wherein the parameters for interacting with the collaborative communication system received from the command resource comprise a parameter indicating how to utilize the result data in presentation by the user interface, and the collaborative communication system presents the result data in accordance with the parameter passed by the command resource.

5. The collaborative communication system according to claim 1, wherein the command input is triggered from a UI widget the user interacts with in the collaborative communication system.

6. The collaborative communication system according to claim 5, wherein the operations further comprising processing a second query associated with the received input by passing the query to a command resource in response to the command input being updated, wherein the second query comprises parameters for the updated command input.

7. The collaborative communication system according to claim 6, wherein the operations further comprising receiving a second response from the command resource based on the parameters of the updated command input and the context associated with the authoring, wherein the second response comprises updated result data and parameters for interacting with the collaborative communication system.

8. The collaborative communication system according to claim 7, wherein the operations further comprising presenting the updated result data in the user interface, and in response to receiving a selection corresponding with the result data, inserting selected result data inline into a communication being authored in the user interface of the collaborative communication system.

9. A computer-readable storage device including executable instructions, that when executed on at least one processor, causing the processor to perform a process comprising:
receiving registration data of a command handler from an external resource for a command that is executable in a collaborative communication service, wherein the registration data comprises parameters defining a command associated with the command handler;
storing the registration data in a storage for the collaborative communication service;
in response to receiving declaration of input in the collaborative communication service, utilizing the parameters defining the command to determine whether the input triggers the command handler; and
in response to determining that the input triggers the command handler, presenting the stored command handler for display in a user interface of the collaborative communication service.

10. The computer-readable storage device according to claim 9, wherein the presenting of the stored command handler displays an auto-completed command handler in response to determining that the input triggers the command handler.

11. The computer-readable storage device according to claim 9, where the process further comprises receiving, from the external resource, an update to the registration data of the command handler, and updating the stored registration data based on the received update to the registration data.

12. A computer-implemented method comprising:
in response to command input being received during authoring in a user interface of a collaborative communication service, transmitting, to an external resource, a first query that comprises parameters of the command input and a context associated with the authoring;
receiving a first response from the external resource based on the parameters of the command input and the context, wherein the first response comprises result data and parameters for interacting with the collaborative communication service;
presenting the result data in the user interface;
in response to update to the command input, transmitting, to the external resource, a second query that comprises parameters of the updated command input;
receiving a second response from the external resource based on the parameters of the command input and the context provided by the first query, wherein the second response received comprises updated result data; and
presenting the updated result data in the user interface.

13. The computer-implemented method according to claim 12, further comprising registering, in a storage associated with the collaborative communication service, data associated with a command handler received from the external resource for a command that is executable in the collaborative communication service, wherein the registered data comprises parameters defining the command associated with the command handler.

14. The computer-implemented method according to claim 13, further comprising in response to the command input being received, utilizing the parameters of the registered data to determine whether the command input triggers the command handler, and in response to determining that the command input triggers the command handler, presenting the command handler for display in the user interface.

15. The computer-implemented method according to claim 14, wherein the presenting of the stored command handler further comprises displaying an auto-completed command handler in response to determining that the command input triggers the command handler.

16. The computer-implemented method according to claim 13, further comprising updating, in the storage associated with the collaborative communication service, the registered data corresponding to the command handler.

17. The computer-implemented method according to claim 16, further comprising in response to the command input being received, utilizing the parameters of the updated registered data to determine whether the command input triggers the command handler, and in response to determining that the command input triggers the command handler, presenting the command handler for display in the user interface.

18. The computer-implemented method according to claim 12, further comprising identifying the command input based on receipt of a trigger from a user, wherein the trigger is an input of at least one of an entered character, number, symbol, word, and selected item in the user interface.

19. The computer-implemented method according to claim 12, wherein the presenting of the result data further comprises inserting the result data inline into a communication being authored in the user interface.

20. The computer-implemented method according to claim 19, wherein the presenting of the updated result data further comprises replacing the result data in the communication with the updated result data.
